(19) United States
(12) Patent Application Publication
(10) Pub. No.: US 2026/0301260 A1
(43) Pub. Date: Oct. 1, 2026

(54) Generating Synthetic Data Associated with Graphical Text Stylization and Animation

(71) Applicant: Google LLC, Mountain View, CA (US)

(72) Inventors: Sourish Chaudhuri, San Francisco, CA (US); Luciano Sbaiz, Zürich (CH); Daniel V. Klein, Pittsburgh, PA (US)

(21) Appl. No.: 19/097,527

(22) Filed: Apr. 1, 2025

(51) Int. Cl. G06T 11/60; G06F 40/40; G06T 13/00; G06V 30/19

(52) U.S. Cl. CPC G06T 11/60; G06T 13/00; G06F 40/40; G06V 30/19147

(57) ABSTRACT

Example embodiments of the present disclosure provide an example method for managing computer systems and networks that can generate template descriptions associated with graphical text. The computer systems and networks can generate the template descriptions associated with the graphical text via a template description generation pipeline. The machine-learned models can utilize the template descriptions associated with the graphical text to generate images and/or videos with graphical text. The machine-learned models can generate the images and/or videos with the graphical text, via an instance rendering pipeline. The images and/or videos with the graphical text can then be utilized to train another machine-learned model.

### FIELD

The present disclosure relates generally to machine learning processes and machine-learned devices and systems. More particularly, the present disclosure relates to improved generation of synthetic data associated with videos, graphical text in the videos, and descriptions of the videos.

### BACKGROUND

Machine-learned devices and systems may be unable to process images or videos with on-screen text. The machine-learned devices and systems may incorrectly or incompletely process the text, such as graphical text overlaying other portions of the images or videos. The machine-learned devices and systems may be unable to properly insert new graphical text, replace overlaid graphical text with different text, improve quality levels of graphical text, or perform various other types of graphical-text related operations. Quantities and qualities of training data utilized to train machine-learned devices and systems to process graphical text may be sparse and insufficient, which may lead to poor performance from generalization and other learned biases.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining an animation template, the animation template may include an image may include graphical text and a first background, where the graphical text may include one or more first words rendered with a particular stylization. The method also includes generating, with a generative language model, a natural language description based on a plurality of tags that may include data representing a plurality of attributes associated with the graphical text and the animation template. The method also includes selecting one or more second words and a second background. The method also includes generating an augmented description based on the natural language description, the one or more second words and the second background. The method also includes generating, with a rendering engine, a rendered image based on a template and the augmented description, where the rendered image may include rendered text and the second background, where the rendered text may include the one or more second words rendered with the particular stylization. The method also includes generating a training dataset may include the augmented description and the rendered image.

Another example aspect of the present disclosure is directed to a computing system for editing images. The computing system includes one or more processors and a non-transitory, computer-readable medium comprising instructions that, when executed by the one or more processors, cause the one or more processors to perform operations. The operations include obtaining an animation template and at least one attribute tag, where the animation template may include graphical text and a background, where the graphical text may include a plurality of characters rendered with a particular stylization, and where the at least one attribute tag is descriptive of at least one attribute of the particular stylization. The operations also include generating at least one description, with a generative language model, based on the at least one attribute tag, where each of the at least one description may include a placeholder associated with text contents of the animation template. The operations also include generating a meta-description based on the at least one description. The operations also include replacing each of the placeholders of the meta-description with a text string to generate an animation description. The operations also includes generating, with a rendering engine, a rendered image may include the text string with the particular stylization. The operations also include storing the animation description and the rendered image as a training example

Another example aspect of the present disclosure is directed to a non-transitory, computer-readable medium comprising instructions that, when executed by one or more processors, cause the one or more processors to perform operations. The operations include obtaining an animation template and a plurality of attribute tags, where the animation template may include graphical text, where the graphical text is rendered with a particular stylization. The operations also include generating a plurality of different descriptions, with a generative language model, based on the plurality of attribute tags, where each of the plurality of different descriptions may include a placeholder associated with text contents of the animation template. The operations also include generating a natural language description based on the plurality of attribute tags. The operations also include inserting, with the generative language model, instances of a text string into the natural language description to generate an animation description. The operations also include generating, with a rendering engine, and based on a template and the animation description, a rendered image may include the text string with the particular stylization. The operations also include storing the animation description and the rendered image as a training example.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example synthetic data generation system for graphical text stylization and animation from a high-level perspective according to example embodiments of the present disclosure;

FIG. 2 depicts a block diagram of an example synthetic data generation system for graphical text stylization and animation with additional details according to example embodiments of the present disclosure;

FIG. 3 depicts a flow chart diagram of an example method to perform natural language description and rendered image generation according to example implementations of aspects of the present disclosure;

FIG. 4 depicts a block diagram of an example template-description generation pipeline in a synthetic data generation system for graphical text stylization and animation according to example embodiments of the present disclosure;

FIG. 5 depicts a block diagram of an example instance rendering pipeline in a synthetic data generation system for graphical text stylization and animation according to example embodiments of the present disclosure;

FIG. 6 depicts a block diagram of example database data collected from a synthetic data generation system for graphical text stylization and animation, the database data being usable by media content management systems according to example embodiments of the present disclosure;

FIG. 7 depicts example images processed by a synthetic data generation system for graphical text stylization and animation according to example embodiments of the present disclosure;

FIG. 8 depicts an example environment with a synthetic data generation system, one or more client servers, one or more user devices, the synthetic data generation system being utilized for graphical text stylization and animation according to example embodiments of the present disclosure;

FIG. 9 depicts a flow chart diagram illustrating an example method to perform description generation of graphical text and generation of rendered images with text strings having particular stylization according to example implementations of aspects of the present disclosure;

FIG. 10 depicts a flow chart diagram illustrating an example method to perform description generation of graphical text and generation of rendered images with text strings having particular stylization according to example implementations of aspects of the present disclosure;

FIG. 11 depicts a block diagram of an example computing system that performs graphical text stylization and animation according to example embodiments of the present disclosure;

FIG. 12 depicts a block diagram of an example computing system that performs graphical text stylization and animation according to example embodiments of the present disclosure;

FIG. 13 depicts a flow chart diagram illustrating an example method for training a machine-learned model according to example implementations of aspects of the present disclosure;

FIG. 14 depicts a block diagram of an example processing flow for using machine-learned model(s) to process input(s) to generate output(s) according to example implementations of aspects of the present disclosure;

FIG. 15 depicts a block diagram of an example sequence processing model according to example implementations of aspects of the present disclosure;

FIG. 16 depicts a block diagram of an example technique for populating an example input sequence for processing by a sequence processing model according to example implementations of aspects of the present disclosure;

FIG. 17 depicts a block diagram of an example model development platform according to example implementations of aspects of the present disclosure;

FIG. 18 depicts a block diagram of an example training workflow for training a machine-learned model according to example implementations of aspects of the present disclosure;

FIG. 19 depicts a block diagram of an inference system for operating one or more machine-learned model(s) to perform inference according to example implementations of aspects of the present disclosure;

FIG. 20 depicts a block diagram of an example networked computing system according to example implementations of aspects of the present disclosure;

FIG. 21 depicts a block diagram of an example computing device according to example implementations of aspects of the present disclosure;

FIG. 22 depicts a block diagram of an example computing device according to example implementations of aspects of the present disclosure.

### DETAILED DESCRIPTION

Generally, the present disclosure is directed to computer-implemented systems and methods that leverage machine-learned models to generate synthetic data associated with graphical text stylization and animation. The machine-learned models (e.g., first machine-learned models) can generate, via a template description generation pipeline, template descriptions associated with graphical text. The machine-learned models can utilize the template descriptions to generate, via an instance rendering pipeline, images and/or videos with graphical text, which can then be utilized to train another machine-learned model (e.g., a second machine-learned model).

Training data used to train machine-learned models can include the synthetic data, which can be utilized as machine-learned model generated training data. Synthetic video data may be generated by a machine-learned model that is trained to reproduce the characteristics and structure of an original image and/or original video data.

The synthetic data can be generated by generative models and/or be utilized to train generative models. Generative models can automatically generate video data of various versions (e.g., a version that adds or erases a person, a version that adds clouds or text, etc., or any combination thereof), and/or translate video data into other versions. Alternatively or additionally, generative models can automatically generate video data of various types (e.g., HD videos, SD videos, GIF videos, WAV videos, MPEG videos, etc., or any combination thereof), and/or translate video data into other types of video data. Alternatively or additionally, generative models can automatically generate video data of various types, and/or translate video data into other types of video data.

Videos can include various types of objects, and, possibly, graphical text. Generative models can process video data by inserting the graphical text into the video data, which also may initially include other types of text, such as ingrained, natural, and/or original text. Generative models can perform various other text-oriented operations with respect to portions of frames within the videos. For example, generative models can overlay text, replace text (e.g., text can be replaced for translations, such as by replacing text that includes “ [symbol] ,” in Russian to text that includes “Bobby's Place,” in English), embed text (e.g., titles and/or captions can be embedded), perform any number of various other text-oriented operations, or any combination thereof.

The synthetic data may be generated based on video descriptions and videos generated utilizing the video descriptions. The video descriptions can be generated by a generative language model based on animation templates by compiling together groups of attribute descriptions regarding attributes of the animation templates. The animation templates may include graphical text. The videos can be generated using the video descriptions and with different graphical text than in the animation templates. The video descriptions and the videos can be stored as training data.

Generative models according to conventional technology can have difficulties in properly generating active/dynamic text that is customized and overlaid over content within videos. Existing models can fail to identify and/or reproduce stylization for the text and/or animations associated therewith. One potential hurdle may include over generalization based on a limited training corpus. Generative models may be unable to generate active and/or dynamic text, such as for text overlays, with sufficient quality, accuracy, and precision. Generative models, not being correctly trained to correlate descriptions with particular stylization characteristics, may output videos with hallucinations, especially with respect to text that is overlaid in the videos.

Generative models according to conventional technology may be incapable of properly generating graphical text. Existing generative model systems can fail to reliably and faithfully render text stylization (e.g., animations, font choices, etc.) based on receiving a given prompt. Generative systems drop, transpose, hallucinate, and/or substitute letters in the text, in particular with respect to longer text phrases/passages that are relatively more difficult for generative systems to accurately produce in images. Generative systems may autocorrect spellings of words, notwithstanding original spellings, which may be identified by the generative systems via autocorrect as wrong spellings, being intentional.

Machine-learned models according to the techniques discussed herein can leverage templates and descriptive tags to generate synthetic training descriptions and synthetic template image instances. The machine-learned models can include generative models (e.g., large language models) that process the templates to generate example prompt strings descriptive of the features depicted in the template. For example, the prompt strings may include “‘STYLE’: ‘The text exhibits a retro minimalist style;’” “‘USE’: ‘Bold text style is used for titles;’” “‘EMOTION’: ‘The text style evokes emotions of relaxation and neutrality;’” “‘FONT ATTRIBUTES’: ‘The text is in bold, sans serif, all caps;’” “‘COLORS’: ‘The text combines 2 colors, an orange hue and pastel tones;’” “‘SPEED’: ‘The text slowly animates across the screen.’”

For each of any number of templates, a machine-learned model can select a subset of tags from different categories (e.g., color palette, emotion expressed, style, use-case, animation speed, font(s) used, etc.) and process the subset (e.g., and the prompt strings) to generate a natural language description of the template that has placeholders for text to be rendered. For example, tags can include “orange hue,” “relaxation,” “neutrality,” “titles,” “pastel tones,” “retro minimalist,” “slow animation,” “bold,” “sans serif,” “all caps,” etc. In such an example, the description (e.g., the generated natural language description), can specify that “the stylized text, %text%, is presented in a retro minimalist style, evoking emotions of relaxation and neutrality; it exhibits a bold text style that is used for titles, emphasizing their importance; the text, %text%, is in bold, sans serif, and all caps, using an orange hue and pastel tones for a visually appealing combination; and, additionally, the text, %text%, slowly animates across the screen, adding a dynamic element to the design.”

The machine-learned model can generate templates and descriptive tags in response to receiving various types of input, which may include automated and/or manual input. The machine-learned model can generate templates that are stylized and animated and that include information about color palettes, motion, effects, etc., of each template.

The machine-learned model can process natural language descriptions. For each of any number of descriptions, the machine-learned model can select an animation template. The machine-learned model can select, from color lists and video/image sources, combinations of background colors and videos/still images, respectively. The machine-learned model can select a short phrase from input text. The machine-learned model can render the animation template to generate an instance of an image and/or a video with the corresponding template and the phrase. Various types of systems can store, as training data, the image/video, the phrase, the corresponding tags/font attributes, the text, and the natural language descriptions. The systems can utilize the training data for training a variety of different models for a variety of different downstream tasks.

Training data generated utilizing the templates and natural language descriptions can be leveraged to train font-recognition models to more reliably and effectively identify fonts in videos. Moreover, the generated training data can be utilized to train text-to-image/video generation models for improved stylized text generation (e.g., animated text and/or text in a particular font). The training data can be utilized to accurately and efficiently perform animation training, text inpainting, text replacement, etc.

A technical effect of example implementations of the present disclosure is increased energy efficiency in performing operations using machine-learned models for graphical text stylization and animation, thereby improving the functioning of computers implementing such models. For instance, example implementations can provide for more energy-efficient runtime execution or inference. In some scenarios, increased energy efficiency can provide for less energy to be used to perform a graphical text stylization and animation-related task (e.g., less energy expended to maintain the model in memory, less energy expended to perform calculations within the model, etc.). In some scenarios, increased energy efficiency can provide for more graphical text stylization and animation-related task(s) to be completed for a given energy budget (e.g., a larger quantity of tasks, more complex tasks, the same graphical text stylization and animation-related task but with more accuracy or precision, etc.).

In this manner, for instance, the improved energy efficiency of example implementations of the present disclosure can reduce an amount of pollution or other waste associated with implementing machine-learned models and systems utilized for graphical text stylization and animation-related. Therefore, the field of machine-learning and artificial intelligence is advanced as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of graphical text stylization and animation-related machine-learned models can be reduced by implementing more energy-efficient training or inference operations. An amount of heat pollution in an environment (e.g., by the processors/storage locations) can be reduced by implementing more energy-efficient training or inference operations.

The improvements associated with the systems and methods discussed herein can be further understood with reference to the figures. Reference now is made to the figures, which provide example arrangements of computing systems, model structures, and data flows for illustration purposes only.

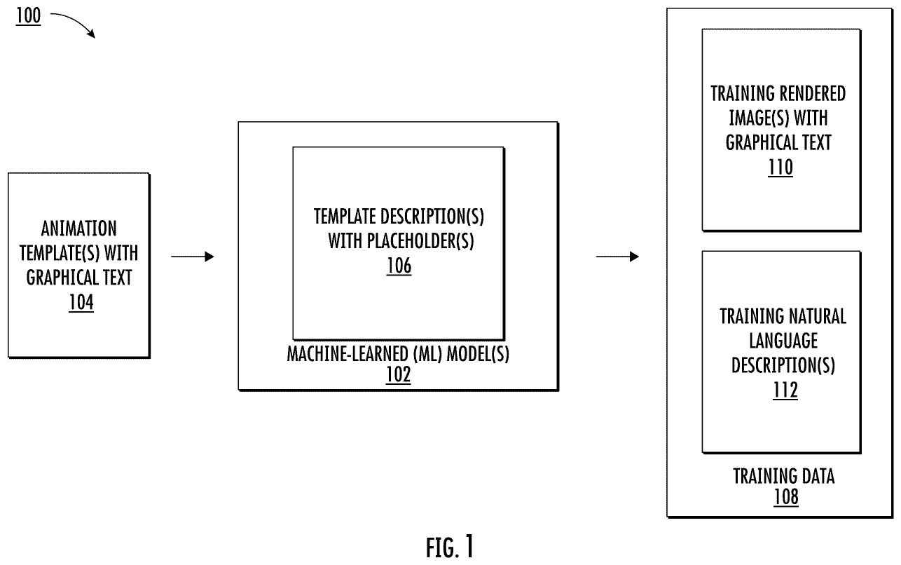

FIG. 1 depicts a block diagram of an example synthetic data generation system 100 for graphical text stylization and animation from a high-level perspective according to example embodiments of the present disclosure.

The data generation system 100 can include one or more machine-learned models 102. The machine-learned model(s) 102 can process various types of input content. The input content can include one or more animation templates with graphical text (the animation template(s) with graphical text also being referred to herein simply as “animation template(s)”) 104. The graphical text may include text with various types of stylization, such as motion.

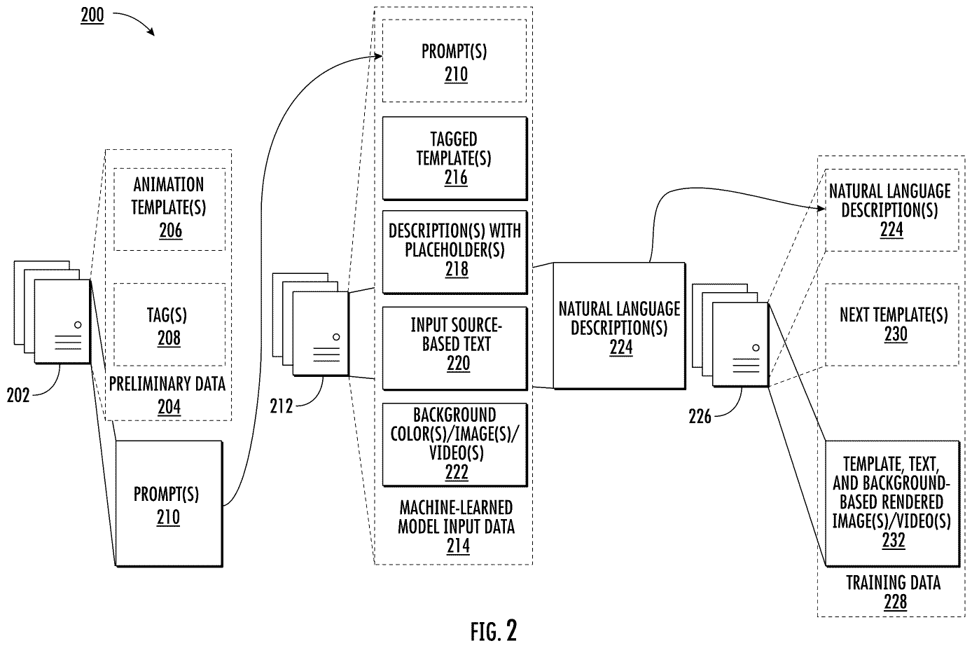

The machine-learned model(s) 102 can generate one or more template descriptions with one or more placeholders (the template description(s) with placeholder(s) also being referred to herein simply as “template description(s)”) 106 based on the animation template(s)” 106. The template description(s) 106 can include various types of content associated with the animation template(s) 104 (e.g., the animation template(s) 206 and/or the tagged template(s) 216, as discussed below in further detail with respect to FIG. 2).

Various types of animation templates (e.g., any of the animation template(s) 104) may be processed by the machine-learned model(s) 102. In some examples, individual ones of the animation template(s) 104 can include one or more images, one or more videos, graphical text (e.g., one or more portions of graphical text), etc., or any combination thereof. For instance, graphical text in an animation template 104 can include one or more groups of words, one or more phrases, one or more sentences, one or more of any type of grammatical elements, etc., or any combination thereof, such as any number of symbols individually representing an alphanumeric character, a logograph, and so on, or any combination thereof. Alternatively or additionally, graphical text in an animation template 104 can include any other number of any types of other symbols (e.g., one or more grammatical elements, one or more emojis, one or more other symbols of any type, one or more icons, and so on, or any combination thereof), etc., or any combination thereof. The graphical text may include dynamic text, animated text, any type of text in motion and/or with stylization, or any combination thereof. In some examples, the animation template(s) 104 may be generated by one or more systems (e.g., the system 100 including the machine-learned model(s) 102, one or more other systems including one or more other machine-learned models, or any combination thereof).

In some examples, for instance with any of the animation template(s) 104, the animation template 104 can include any graphical text. The animation template 104 can include, as the graphical text, evolving text. The evolving text may include graphical text flying into the animation template 104 from a space (e.g., an unseen space) outside of the animation template 104. The evolving text may include graphical text (e.g., iteratively revealing text) that is iteratively revealed, such as text being revealed repeatedly, cyclically, recurrently, and/or regularly over time.

Various types of template descriptions (e.g., any of the template description(s) 106) may be associated with any type of template (e.g., any of the animation template(s) 104). In some examples, individual ones of the template description(s) 106 can include a natural language description of a template (e.g., an animation template 104). For instance, a template description 106 can include one or more groups of words, one or more phrases, one or more sentences, one or more of any type of grammatical elements, etc., or any combination thereof, such as any number of symbols individually representing an alphanumeric character, a logograph, any other type of character, etc., or any combination thereof. The template description 106 can include one or more descriptions, one or more characterizations, one or more explanations, one or more depictions, one or more representations, one or more interpretations, one or more narratives, etc., of any one or more aspects related to the animation template 104 (e.g., and/or graphical text therein). The aspect(s) can include one or more attributes, one or more tags, one or more characteristics, one or more parameters of the characteristic(s), etc., or any combination thereof.

The template description(s) 106 can be generated based on the animation template(s) 104 and/or various attributes associated with the animation template(s) 104. For example, a template description 106 can be generated based on the animation template(s) 104. Alternatively or additionally, the template description 106 can be generated based on one or more attributes of the animation template(s) 104. In such an example or another example, the template description 106 can be generated based on one or more tags.

Various types of tags may be utilized to generate the template description 106. The tag(s) may correspond to, and/or be associated with, the attribute(s). The tag(s) may include one or more descriptions (or “attribute description(s)”) (e.g., one or more descriptions being different from one another), which may correspond to, and/or be associated with, the attribute(s). In various instances, the attribute description(s) may be generated based on, and/or may include text describing, the attribute(s).

The tags can include various types of tags (e.g., any of the tag(s) 208, as discussed below with reference to FIG. 2) associated with any type of template (e.g., any of the animation template(s) 104). In some examples, individual ones of the tags can include a natural language tag associated with an attribute of the template. For instance, a tag can include one or more groups of words, one or more phrases, one or more sentences, one or more of any type of grammatical elements, etc., or any combination thereof, such as any number of symbols individually representing an alphanumeric character, a logograph, any other type of character, etc., or any combination thereof. The tag can include one or more descriptions, one or more characterizations, one or more explanations, one or more depictions, one or more representations, one or more interpretations, one or more narratives, etc., of any one or more attributes of the animation template 104 and/or graphical text therein. In some examples, the tag(s) can be utilized, possibly along with one or more prompts (e.g., the prompt(s) 210, as discussed below with reference to FIG. 2) associated therewith, to generate the template description(s) 106. In those or other examples, the tag(s) and/or the prompt(s) may be generated by one or more systems (e.g., the system 100 including the machine-learned model(s) 102, one or more other systems including one or more other machine-learned models, or any combination thereto).

Any number of placeholders (e.g., one or more placeholders) can be included in the template description 106. The placeholder(s) in the template description 106 can be utilized to enable text to be subsequently utilized (e.g., provided, inserted, etc.) in the template description 106. For example, inserting text in the placeholder(s) of the template description 106 can be performed to enable completion of the template description 106.

The placeholder(s) can include various types of placeholders (e.g., any of the placeholder(s) in the description(s) 218, as discussed below with respect to FIG. 2) associated with any type of template (e.g., any of the animation template(s) 104). In some examples, individual ones of the placeholder(s) can include one or more placeholder symbols (e.g., “%XX%,” “%text%,” “%header%,” “*text*,” etc.), one or more fields, one or more of any other types of placeholders, etc., or any combination thereof. The placeholder(s) can be associated with, included in, inserted in, linked to, etc., any of the template descriptions 106, and/or portions therein. For instance, a placeholder can include any number of symbols individually representing an alphanumeric character, a logograph, any other type of character, etc., or any combination thereof. The placeholder(s) can be identified by the machine-learned model(s) 102, based on the machine-learned model(s) 102 identifying any group of the placeholder symbol(s) as any of the placeholder(s).

The machine-learned model(s) 102 can utilize any number of the template description(s) 106 to generate output content. The output content can include training data 108. The training data 108 can include one or more training rendered images with graphical text (the training rendered image(s) with graphical text also being referred to herein simply as “training rendered image(s)” or “rendered image(s)”) 110. Alternatively or additionally, the training data can include one or more training natural language descriptions 112.

The training rendered image(s) 110 can be generated based on the description(s) and one or more templates (e.g., one or more other templates, such as one or more source templates; one or more rendered templates; one or more other templates; or any combination thereof). For instance, the source template(s) (also simply referred to herein as “template(s)”) can include individual ones of the animation template(s) 206, individual ones of the tagged template(s) 216, one or more of any templates stored in, and/or processed by, the server(s) 212, one or more of any templates stored in, and/or processed by, the server(s) 202, one or more of any templates (e.g., the next template(s) 230 as discussed below with reference to FIG. 2) stored in, and/or processed by, the server(s) 226 any number of any other templates, or any combination thereof. Alternatively or additionally, the training rendered image(s) 110 can be generated based on one or more phrases and/or one or more backgrounds. For instance, a training rendered image 110 can be generated based on a phrase and a background. In such an instance or another instance, rendered graphical text in the training rendered image 110 may be generated based on the phrase.

Various types of rendered images (e.g., any of the rendered image(s) 110) may be generated by the machine-learned model(s) 102. In some examples, individual ones of the rendered image(s) 110 can include, and/or represent, one or more images, one or more videos, graphical text (e.g., one or more portions of graphical text), etc., or any combination thereof. For instance, graphical text in a rendered image 110 can include one or more groups of words, one or more phrases, one or more sentences, one or more of any type of grammatical elements, etc., or any combination thereof, such as any number of symbols individually representing an alphanumeric character, a logograph, any other type of character, etc., or any combination thereof. The graphical text, which may be the same type as, or a different type from, the graphical text in the animation template 104. The graphical text in the rendered image 110 may include dynamic text, animated text, any type of text in motion and/or with stylization, or any combination thereof. In some examples, the rendered image 110 may be generated by one or more systems (e.g., the system 100 including the machine-learned model(s) 102, one or more other systems including one or more other machine-learned models, or any combination thereof).

The training natural language description(s) 112 can be generated based on the template description(s) 106, the phrase(s), and the backgrounds. For instance, a training natural language description 112 can be generated based on the phrase and the background. In such an instance or another instance, the phrase may be inserted in the placeholder(s) of the template description(s) 106. In such an instance or another instance, the training natural language description 112 can specify the background. Individual ones of one or more phrases in any of the template(s), with which the training natural language description(s) 112 may be associated, can include one or more of any type of elements, etc., or any combination thereof, such as any number of symbols individually representing an alphanumeric character, a logograph, and so on, or any combination thereof. Alternatively or additionally, individual ones of the phrase(s) can include any other number of any other types of symbols (e.g., one or more grammatical elements, one or more emojis, one or more other symbols of any type, one or more icons, and so on, or any combination thereof).

While the training rendered image(s) 110 and the training description(s) 112 can be included in the training data 106 as discussed above in the current disclosure, it is not limited as such. In some examples, various types of pairs of images/videos and descriptions can be included in the image(s) 110 and the description(s) 112, respectively. For example, according to a class (e.g., a first class) of images/videos and descriptions, the image(s) 110 can represent a single sequence of images or videos. According to the first class, the description(s) 112 can represent a natural language description that describes the single sequence. In alternative or additional examples, according to a class (e.g., a second class) of images/videos and descriptions, the image(s) 110 can represent two sequences of images or videos. According to the second class, the description(s) 112 can represent a natural language description that includes information about how to transform one of the two sequences into the other of the two sequences. Alternatively or additionally, according to the second class, the description(s) 112 can represent a natural language description that describes the two sequences.

Data utilized to train the machine-learned model(s) 102 may be similar to, or different from, the data in the image(s) 110 and/or the description(s) 112, respectively, according to the first and/or second classes. For example, the animation template(s) and/or the description(s) 106 may be similar to the image(s) 110 and/or the description(s) 112, respectively, according to the first and/or second classes. Alternatively or additionally, the image(s) 110 and/or the description(s) 112 according to the first and/or second classes can be input as the animation template(s) and/or the description(s) 106 into the machine-learned model(s) 102.

While the animation template(s) 104 and/or the tag(s) may be extracted by various systems, and/or the prompt(s) may be extracted and/or generated by various systems, as discussed above in the current disclosure, it is not limited thereto. In some examples, individual ones the animation template(s) 104 and/or individual ones of the tag(s) can be generated by one or more servers; and/or individual ones the animation template(s) 104 and/or individual ones of the tag(s) can be extracted from one or more humans, such as, for example, via one or more selections (or “user selection(s)”) input to any of the systems (e.g., the system 100, and/or one or more computing devices communicatively coupled thereto). In those or other examples, individual ones of the prompt(s) can be generated by one or more servers; and/or individual ones of and/or the prompt(s) can be extracted from one or more humans, such as, for example, via one or more selections (or “user selection(s)”) input to any of the systems (e.g., the system 100, and/or one or more computing devices communicatively coupled thereto).

The training data 108 can be utilized in various ways, For example, the training data 108 can be utilized to train generative models. The trained generative models can automatically generate video data of various versions (e.g., a version that adds or erases a person, a version that adds clouds or text, etc., or any combination thereof), and/or translate video data into other versions. Alternatively or additionally, the trained generative models can automatically generate video data of various types (e.g., HD videos, SD videos, GIF videos, WAV videos, MPEG videos, etc., or any combination thereof), and/or translate video data into other types of video data.

The generative models being trained with the training data 108 can process video data by inserting graphical text into the video data, which also may initially include other types of text, such as ingrained, natural, and/or original text. The trained generative models can perform various other text-oriented operations. For instance, the trained generative models can perform various other text-oriented operations with respect to portions of frames within the videos. In some examples, the trained generative models can overlay text (e.g., graphical text), replace text (e.g., graphical text), and/or embed text (e.g., graphical text) of various types, perform any number of various other text-oriented operations (e.g., graphical text-oriented operations), or any combination thereof.

FIG. 2 depicts a block diagram of an example synthetic data generation system 200 for graphical text stylization and animation with additional details according to example embodiments of the present disclosure. The synthetic data generation system 200 can include one or more servers 202. The server(s) (or “setup servers”) 202 can be utilized to manage (e.g., set up, receive, identify, determine, generate, modify, update, delete, etc., or any combination thereof) various types of data. The server(s) 202 may perform one or more operations at a preliminary stage for enabling graphical text stylization and animation.

The data managed by the server(s) 202 can include various types of data utilized to perform graphical text stylization and animation. The data managed by the server(s) 202 preliminary data 204 and prompt data. For example, the preliminary data 204 may be obtained preliminarily to performing any other operations.

The preliminary data 204 can include one or more animation templates 206 and/or one or more tags 208. Any of the animation template(s) 206 can include graphical text. The graphical text can include dynamic text, animated text, any type of text in motion and/or with stylization, or any combination thereof. For example, any of the animation template(s) 206 can include at least one color (e.g., at least one background color), at least one image, and/or at least one video. Individual ones of animation template(s) 206 may be managed (e.g., identified, determined, received, extracted, etc.) by one or more servers (e.g., the server(s) 202, one or more other servers, or any combination thereof), prior to the tag(s) 208 being managed (e.g., identified, determined, received, extracted, etc.) by the server(s) 202, the other server(s), or any combination thereof). For example, an animation template 206 may be identified, prior to at least one corresponding tag from among the tag(s) 208 being extracted based on the animation template 206.

In such an example or another example, any of the tag(s) (or “descriptive tag(s)”) 208 can identify, and/or include a description of, one or more attributes. Individual ones of the tag(s) 208, and/or individual ones of the attribute(s) identified by the tag(s) 208, may be associated with a corresponding template from among the animation template(s) 206. The server(s) 202 may link, and/or be controlled to link, at least one tag 208 that is extracted for, and/or associated with, the corresponding template 206.

The data managed by the server(s) 202 can include one or more prompts 210. Any of the prompt data can include, be included in, and/or be associated with, the prompt(s) 210. In various examples, any of the prompt(s) (or “prompt string(s)”) 210 can include, and/or be extracted (e.g., from user input received by the server(s) 202) and/or generated based on, a string of one or more characters (e.g., one or more ascii characters) describing the attribute(s) identified via a corresponding tag 208. For instance, a prompt 210 may include “‘STYLE’: ‘The text exhibits a retro minimalist style;’” “‘USE’: ‘Bold text style is used for titles;’” “‘EMOTION’: ‘The text style evokes emotions of relaxation and neutrality;’” “‘FONT ATTRIBUTES’: ‘The text is in bold, sans serif, all caps;’” “‘COLORS’: ‘The text combines 2 colors, an orange hue and pastel tones;’” or “‘SPEED’: ‘The text slowly animates across the screen.’”

The synthetic data generation system 200 can include one or more servers 212 to perform one or more operations, alternatively or additionally to any of the operation(s) performed by the server(s) 202. The server(s) (or “intermediary servers”) 212 can be utilized to manage (e.g., receive, identify, determine, generate, modify, update, delete, etc., or any combination thereof) various types of data. The operation(s) of the server(s) 212 may be performed based on any of the data being managed by the server(s) 202 (e.g., based on the preliminary data 204 being processed by the server(s) 202, and/or the prompt(s) 210 being extracted and/or generated by the server(s) 202.

The operation(s) performed by the server(s) 212 for enabling graphical text stylization and animation may be performed, for example, based on the operation(s) of the server(s) 202. The server(s) 212 may perform the operation(s), for example, at an intermediary stage for enabling graphical text stylization and animation.

The operation(s) performed by the server(s) 212 may be performed based on machine-learned model input data 214. The machine-learned model input data 214 may include data utilized by one or more machine-learned models, for example, being managed by the server(s) 212.

The data utilized by the machine-learned model(s) may include various types of data, such as data output from the server(s) and input (e.g., as input data) to the server(s) 212. The input data processed by the server(s) 212 can include the prompt data, such as the prompt(s) 210 received from the server(s) 202. The input data processed by the server(s) 212 can include one or more tagged templates 216, one or more descriptions with one or more placeholders (description(s) with placeholder(s) also being referred to herein simply as “description(s)”) 218, input source-based text 220, one or more background colors/images/videos, one or more other types of data, or any combination thereof.

The tagged template(s) 216 can be identified by the server(s) 212. The tagged template(s) 216 can include any of the animation template(s) 206 being tagged by the tag(s) 208. The tagged template(s) 216 can include at least one of the animation template(s) 206, such as, for example, for any corresponding animation template 206 to which the at least one of the tag(s) 208 has been linked. In some instances, individual ones of the tagged template(s) 216 may be associated with (e.g., described by) at least one corresponding prompt from among the prompt(s) 210. In those or other instances, individual ones of the tagged template(s) 216 may be associated with at least one corresponding tag from among the tag(s) 208. In those or other instances, individual ones of the tagged template(s) 216 may be associated with at least one corresponding attribute from among the attribute(s).

The description(s) 218 can be generated based on the prompt(s) 210. Alternatively or additionally, the description(s) 218 can be generated based on the attribute(s), the tag(s) 208, the tagged template(s) 216, and/or one or more other types of data. Individual ones of the description(s) 218 can be generated, for example, as a combination, an amalgamation, an assembly, an integration, etc., of the prompt(s) 210. Individual ones of the description(s) 218 can be generated as a natural language description of a corresponding template from among the tagged template(s) 216. Individual ones of the description(s) 218 can be generated with at least one of the placeholder(s).

The input source-based text 220 can include one or more text strings from an input source. The input source may include, for example, at least one server from among any of the server(s) (e.g., any of the server(s) 202, the server(s) 212, and/or the server(s) 226, as discussed below in further detail, etc.) in the system 200, any of one or more other servers in any of one or more other systems, or any combination thereof. Individual ones of the text string(s) may include one or more characters (e.g., one or more ascii characters), one or more words (e.g., including any of the character(s), one or more phrases (e.g., including any of the character(s) and/or the word(s), one or more logographs, any other text-based data structures of any type, or any combination thereof. For instance, a text string of the input source-based text 220 may include a phrase to be inserted into any of the placeholder(s) of a corresponding description 218.

The background color(s)/image(s)/video(s) 222 can be received from an input source. The input source may include, for example, at least one server from among any of the server(s) in the system 200, any of the other servers in any of the other systems, or any combination thereof.

The server(s) 212 can generate one or more natural language descriptions 224, such as, for example, by analyzing the machine-learned model input data 214. Individual ones of the natural language description(s) 224 can be generated based on, can correspond to, can be associated with, a description 218. For example, a natural language description 224 can be generated by inserting, into a corresponding description 218, a corresponding text (e.g., phrase) from among the input source-based text 220 into each of at least one placeholder in the corresponding description 218. In such an example or another example, generating the natural language description 224 can include modifying, with the corresponding text from among the input source-based text 220, the corresponding description 218. In such an example or another example, generating the natural language description 224 can include identifying the modified description 218 with the corresponding text from among the input source-based text 220, as the natural language description 224.

The synthetic data generation system 200 can include one or more servers 226 to perform one or more operations, alternatively or additionally to any of the operation(s) performed by the server(s) 202 and/or any of the operation(s) performed by the server(s) 212. The operation(s) of the (or “next servers”) server(s) 226 can be performed next to any of the operation(s) performed by the server(s) 202 and/or any of the operation(s) performed by the server(s) 212. The server(s) 226 can be utilized to manage (e.g., receive, identify, determine, generate, modify, update, delete, etc., or any combination thereof) various types of data.

The operation(s) of the server(s) 226 may be performed based on various other types of data. In various cases, the operation(s) of the server(s) 226 may be performed based on any of the data being managed by the server(s) 202 (e.g., based on the preliminary data 204 being processed by the server(s) 202, and/or the prompt(s) 210 being generated by the server(s) 202). Alternatively or additionally, the operation(s) of the server(s) 226 may be performed based on any of the data being processed by the server(s) 212 (e.g., based on the machine-learned model input data 214 being processed by the server(s) 212, and/or the natural language description(s) 224 being generated by the server(s) 212).

The server(s) 226 can manage (e.g., receive, identify, determine, generate, modify, update, delete, etc., or any combination thereof) data of various types, including training data 228. The training data 228 may be utilized by the server(s) of the system 200, any of the other server(s), or any combination thereof. For example, one or more machine-learned models of the server(s) of the system 200, any of the other server(s), or any combination thereof, may be trained utilizing the training data 228 to perform one or more of various types of operations.

In some examples, the data, such as the training data 228, being managed by the server(s) 226 can include the natural language description(s) 224. In those or other examples, the data, such as the training data 228, being managed by the server(s) 226 can include any of the machine-learned model input data 214. For instance, with examples in which the data being managed by the server(s) 226 include at least some of the machine-learned model input data 214, the data being managed by the server(s) 226 may include the input source-based text 220 and the background color(s)/image(s)/video(s) 222. In such an instance or another instance, the data being managed by the server(s) 226 may include any other data from among the machined-learned model input data 214.

The training data 228 can include one or more next templates 230. In some examples, individual ones of the next templates 230 can include an image/video. The next template(s) 230 can be managed based on the natural language description(s) 224. In those or other examples, the next template(s) 230 can be managed based on the natural language description(s) 224, along with any of the machined-learned model input data 214, such as the background color(s)/image(s)/video(s) 222. In those or other examples, individual ones of the next template(s) 230 may be missing any graphical text and/or any background/image/video. In various instances, individual ones of the next template(s) 230 can be identified, determined, selected, etc., from among the tagged template(s) 216 (e.g., and/or from among the animation template(s) 206).

The training data 228 can include one or more template, text, and background-based rendered images/videos 232. The template, text, and background-based rendered image(s)/video(s) (also referred to herein simply as “rendered image(s)/video(s)”) 232 can be generated by the server(s) 226. The rendered image(s)/video(s) 232 can be generated, via one or more machine-learned models managed by the server(s) 226. The machine-learned models managed by the server(s) 226 may be the same as, or different from, the machine-learned model(s) being managed by the server(s) 212.

The rendered image(s)/video(s) 232 can be generated based on various types of data. For instance, rendered image(s)/video(s) 232 can be generated based on the natural language description(s) 224 and/or the next template(s) 230. In some examples, the server(s) 226 can generate the rendered image(s)/video(s) 232 with a corresponding script from among the input source-based text 220. In those or other examples, the server(s) 226 can generate the rendered image(s)/video(s) 232 with a corresponding background color/image/video from among the background color(s)/image(s)/video(s) 222.

The training data 228 may include various combinations of data. For instance, the training data 228 may include, alternatively or additionally to the natural language description(s) 224, the next template(s) 230, and/or the rendered image(s)/video(s) 232, the input source-based text 220 and the background color(s)/image(s)/video(s) 222. In such an instance or another instance, the training data 228 may include any other data among the machined-learned model input data 214, such as the prompt(s) 210, the tagged template(s) 216, and/or the description(s) 218. In such an instance or another instance, the training data 228 may include any other data from among the preliminary data 204, such as the animation template(s) 206 and/or the tag(s) 208. In some examples, any portion/instance of the training data 228 (e.g., a portion/instance that includes a natural language description 224, a template 230, a rendered image/video 232, input source-based text 220, and/or a background 222) may be generated as a template and included in the training data 228.

Although the server(s) 202, 212, and 226 may be included in the system 200, as discussed above in the current disclosure, it is not limited as such. In some examples, any of the server(s) 202, 212, and 226 may be integrated with one another to perform any of the operations associated therewith.

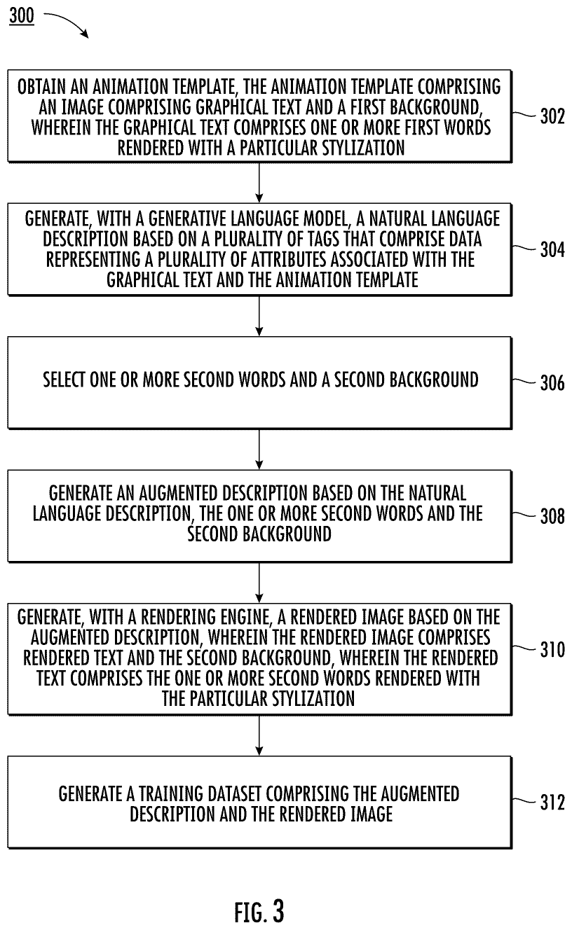

FIG. 3 depicts a flow chart diagram of an example method 300 to perform natural language description and rendered image generation according to example implementations of aspects of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure. The steps of the method 300 can be performed utilizing the system(s) 100, 200, 400, 500, and/or 600, as discussed above with reference to FIGS. 1, 2, 4, 5, and/or 6, respectively.

At 302, a computing system can obtain an animation template, the animation template comprising an image comprising graphical text and a first background, wherein the graphical text comprises one or more first words rendered with a particular stylization. The image can be included in an animation template in a template/tag pair 404. A set of descriptive tags (e.g., a set of the tags 208) corresponding to the animation template in the template/tag pair 404 can be obtained. The image in the animation template, in the template/tag pair 404, can be processed by the server(s) 202 to generate prompts 210 associated with the tags 208, respectively. In some examples, individual one of the prompts 210 may be associated with at least two tags 208. The one or more first words rendered with the particular stylization may be in the animation template 206. The one or more first background may be in the animation template 206.

At 304, the computing system can generate, with a generative language model, a natural language description based on a plurality of tags that comprise data representing a plurality of attributes associated with the graphical text and the animation template. The generative language model can be managed via the server(s) 212. The generative language model can be utilized to generate the natural language description, which can include a natural language description 224. The natural language description 224 can be generated based on the tags 208. Individual ones of the tags 208 can include, and/or be associated with, an attribute. In some examples, individual ones of the tags 208 can include, and/or be associated with more than one attribute. Individual ones of the attributes may be associated with the graphical text and the animation template 404. The natural language description 224, or any other natural language description (e.g., any of the natural language description(s) 224), can be utilized as a template description 504, input into an instance rendering pipeline 502.

At 306, the computing system can select one or more second words and a second background. The one or more second words may be rendered with a particular stylization. The one or more second words may be selected as the input source-based text 220. The one or more second words may be selected via an operation to choose a phrase 514. The second background may be selected via an operation to choose a video 516 or an operation to choose a background color 518. The one or more second words may be selected from among a plurality of words in the input text 506. The one or more second background may be selected from among a plurality of backgrounds (e.g., background images, background videos, background colors, or any combination thereof).

At 308, the computing system can generate an augmented description based on the natural language description, the one or more second words and the second background. The augmented description can include a rendering of the template description 504. The rendering of the template description 504 can be generated based on the one or more second words and the second background. The rendering of the template description 504 can be utilized in an operation to create a video clip 524.

At 310, the computing system can generate, with a rendering engine, a rendered image based on the augmented description, wherein the rendered image comprises rendered text and the second background, wherein the rendered text comprises the one or more second words rendered with the particular stylization. The rendered image can be the video clip created by the operation to create the video clip 524. The rendered image can include rendered text of the phrase with the one or more second words. The phrase with the one or more second words can be rendered with the particular stylization.

At 312, the computing system can generate a training dataset comprising the augmented description and the rendered image. The training data set can include the training data 530. The training data 530 can include the rendering of the template description 504. The training data 530 can include the video clip created by the operation to create the video clip 524, based on the rendering of the template description 504.

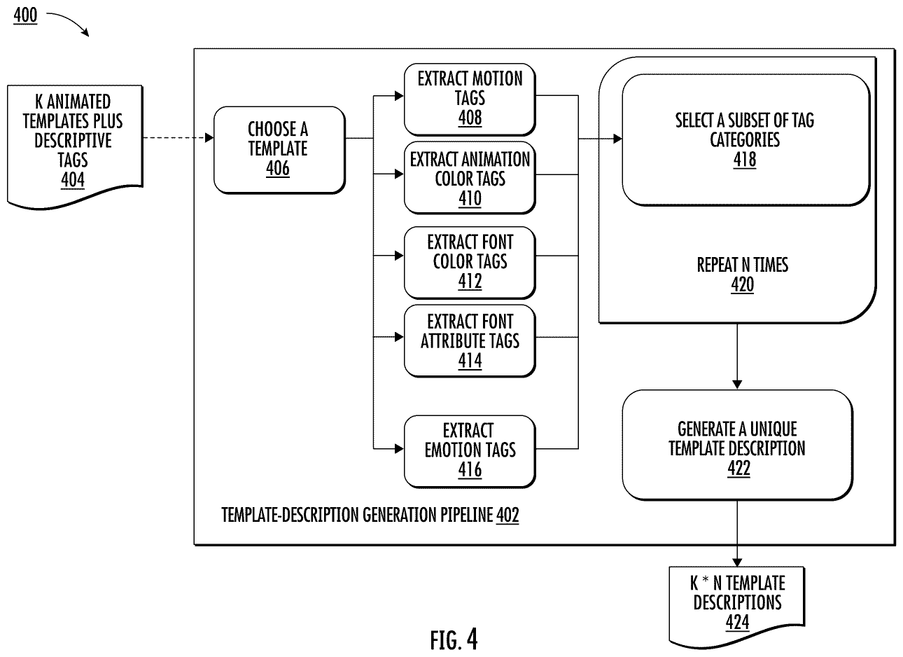

FIG. 4 depicts a block diagram of an example template-description generation pipeline in a synthetic data generation system 400 for graphical text stylization and animation according to example embodiments of the present disclosure. The synthetic data generation system 400 can utilize the template-description generation pipeline, such as a template-description generation pipeline 402 for graphical text stylization and animation. In some examples, the synthetic data generation system 400 can be utilized to implement various portions of the synthetic data generation system(s) 100 and 200, as discussed above with reference to FIGS. 1 and 2. In those or other examples, the template-description generation pipeline (also referred to herein simply as “pipeline”) 402 may be implemented utilizing the machine-learned model(s) managed by the server(s) 212.

The pipeline 402 can be utilized to manage (e.g., receive, identify, determine, process, etc.) one or more combinations of templates and descriptive tags, such as K (e.g., a positive whole number K) animated templates plus descriptive tags (also referred to herein simply as “template/tag pair(s)”) 404. In some examples, the template/tag pair(s) 404 can include some or all of the animation template(s) 206, as discussed above with reference to FIG. 2. In those or other examples, the template/tag pair(s) 404 can include some or all of the tag(s) 208, as discussed above with reference to FIG. 2.

The pipeline 402 can include, and/or be utilized to perform, one or more operation(s), such as any of the operation(s) performed by the server(s) 212. In some examples, at least one of the operation(s) in the pipeline 402 can be performed to choose (e.g., select) a template 206. For instance, to choose the template 206, any of the animation template(s) 206 in the template/tag pair(s) 404 can be selected for the pipeline 402. The selected the animation template(s) 206 may be utilized for performing any of the operation(s) in the pipeline 402. In various cases, the tag(s) 208 in the template/tag pair(s) 404 may include, for individual ones of the selected animation template(s) 206, corresponding sets of tag(s) 208. For instance, a set of tag(s) 208 corresponding to any selected animation template 206 may be identified.

At least one of the operation(s) in the pipeline 402 can be performed to extract motion tags 408, extract animation color tags 410, extract font color tags 412, extract font attribute tags 414, extract emotion tags 416, extract any other tags of various types, etc., or any combination thereof. Any of the tags 408, 410, 412, 414, and 416 may be included in the set of tag(s) 208 corresponding to the animation template(s) 206. Any of the operation(s) performed to extract motion tags may include identifying at least one of one or more attributes associated with a graphical text-related motion of the selected animation template 206. Individual ones of tag(s) 208 corresponding to an attribute (e.g., a motion attribute) from among the at least one attribute may be extracted (e.g., from user input received by the server(s) 202, as discussed above with reference to FIG. 2).

Any of various types of attributes may be associated with any of the tag(s) 208. The at least one motion attribute, and at least one corresponding tag 208, may be associated with a motion of graphical text in the animation template 206. For instance, a motion attribute and a corresponding tag 208 may be associated with a motion of graphical text in the animation template 206. In some examples, the motion may include any type of motion (e.g., of at least one portion of the graphical text), such as scrolling, resizing, popping, sliding, breaking away, hovering, spreading, conjoining, moving, expanding, contracting, rotating, tilting, panning, fading, flickering, blinking, reshaping, morphing, flying in, being revealed (e.g., being iteratively revealed), disappearing, flying out, dimming, etc., or any combination thereof.

Any of the operation(s) performed to extract animation color tags 410 may include identifying at least one of one or more attributes associated with a graphical text-related animation color of the selected animation template 206. Individual ones of tag(s) 208 associated with corresponding animation color attributes may be extracted. The at least one animation color attribute, and the at least one corresponding tag 208, may be associated with at least one corresponding animation color of graphical text in the animation template 206. For instance, an animation color attribute and a corresponding tag 208 may be associated with a corresponding animation color of graphical text in the animation template 206. In some examples, the animation color may include animation of at least one color (e.g., of at least one portion of the graphical text), such as changing, morphing, fading, intensifying, blinking, interspersing, spreading, increasing or decreasing in brightness, diluting, strengthening, etc. or any combination thereof.

Any of the operation(s) performed to extract font color tags 412 may include identifying at least one of one or more attributes associated with a graphical text-related font color of the selected animation template 206. Individual ones of tag(s) 208 associated with corresponding font color attributes may be extracted. The at least one font color attribute, and the at least one corresponding tag 208, may be associated with at least one corresponding font color of graphical text in the animation template 206. For instance, a font color attribute and a corresponding tag 208 may be associated with a corresponding font color of graphical text in the animation template 206. In some examples, the at least one font color attribute, and the at least one tag 208 corresponding to the at least one font color attribute, may be associated with the animation color of graphical text in the animation template 206.

Any of the operation(s) performed to extract font attribute tags 414 may include identifying at least one of one or more attributes associated with a graphical text-related font type/characteristic of the selected animation template 206. Individual ones of tag(s) 208 associated with corresponding font type/characteristic attributes may be extracted. The at least one font type/characteristic attribute, and the at least one corresponding tag 208, may be associated with at least one corresponding font type/characteristic of graphical text in the animation template 206. For instance, a font type/characteristic attribute and a corresponding tag 208 may be associated with a corresponding font type/characteristic of graphical text in the animation template 206. In some examples the font type/characteristic may include any number of font types/characteristics, such as at least one character being bold, having a font type (e.g., sans serif), being capitalized, being lowercase, being italicized, being slanted, being angled, being rotated, being mirrored, being subscripted, being superscripted, being underlined, etc., or any combination thereof.

In various cases, a font type/characteristic attribute of graphical text (e.g., and/or a corresponding tag 208 describing the attribute) can include stylistic, subjective, and/or including technical language. By way of an example, a font type/characteristic attribute of graphical text (e.g., and/or a corresponding tag 208 describing the attribute) can include “Roboto (Business, Stiff, Neo Grotesque) This neo grotesque font conveys a sense of stiff formality, making it suitable for business contexts.” In such an example or another example, a font type/characteristic attribute of graphical text (e.g., and/or a corresponding tag 208 describing the attribute) can include “Open Sans (Active, Humanist, Neo Grotesque) This font blends the active energy of Humanist forms with the clean lines of a Neo Grotesque style.” In such an example or another example, a font type/characteristic attribute of graphical text (e.g., and/or a corresponding tag 208 describing the attribute) can include “Noto Sans JP (Business, Humanist) This font conveys a professional yet approachable feel with its humanist design.”

Any of the operation(s) performed to extract emotion tags 416 may include identifying at least one of one or more attributes associated with a graphical text-related emotion of the selected animation template 206. Individual ones of tag(s) 208 associated with corresponding emotion attributes may be extracted. The at least one emotion attribute, and the at least one corresponding tag 208, may be associated with at least one corresponding emotion of graphical text in the animation template 206. In some examples, the at least one emotion attribute, and the at least one tag 208 corresponding to the at least one emotion attribute, may correspond to the emotion of graphical text in the animation template 206. The emotion may include any number of emotions, such as admiration, adoration, aesthetic appreciation, amusement, anger, anxiety, awe, awkwardness, boredom, calmness, confusion, craving, disgust, empathetic pain, entrancement, excitement, fear, horror, interest, joy, neutrality, nostalgia, relaxation, relief, romance, sadness, satisfaction, sexual desire, surprise, etc. or any combination thereof.

The operation(s) in the pipeline 402 can be utilized to select a subset of tag categories 418. For example, any of the operation(s) to select the subset of tag categories 418 can include selecting at least one of the tag(s) 208. At least one selected tag from among the tag(s) 208 may correspond to a selected subset of tag categories. In some examples, the at least one selected tag 208 may be included in a selected subset of the tag(s) 208. In those or other examples, the subset of the tag(s) 208 may be selected from among the set of the tag(s) 208 associated with the selected animation template 206. Alternatively, the subset of the tag(s) 208 may be selected from among any of the tag(s) 208 associated with any of the animation template 206. Individual ones of the tag(s) 208 in the selected subset may be associated with a category (e.g., a motion, an animation color, a font color, a font type/characteristic, an emotion, etc., or any combination thereof). The selected subset of tag categories and/or the selected subset of the tag(s) 208 may be utilized to identify the selected animation template 206 as a corresponding one of the tagged template(s) 216. In some cases, the operation(s) in the pipeline 402 utilized to select the subset of tag categories 418 can include selecting a random subset of tag categories.

The operation(s) utilized to select the subset of tag categories 418 can include controlling the machine-learned model to utilize the selected tag(s) 208 in a natural language description (e.g., a natural language description with a placeholder for rendered text). For example, the corresponding natural language descriptions in which individual ones of the selected tag(s) 208 are included may be utilized to implement the description(s) 218 that have placeholder(s) for the input source-based text 220, as discussed above with reference to FIG. 2.

Any of operation(s) in the pipeline 402, such as for action 418, can repeat N (e.g., a positive whole number N) times 420. For example, at least one of the operation(s) for action 418 can be repeated to select a different subset of tag categories. Any subsequent occurrences (e.g., repetitions) of any of the operation(s) utilized to select the subset of tag categories 418 may include selecting different subsets of tag(s) 208. By repeating the operation(s) utilized to select the subsets of tag categories 418, N different descriptions (e.g., N different occurrences of the description(s) 218) may be generated. For example, N different descriptions (e.g., N different occurrences of the description(s) 218) may be generated for the selected animation template 206. Any number of groups of N different descriptions (e.g., N different occurrences of the description(s) 218) may be generated for individual ones of the K animation template(s) 206.

At least one of the operation(s) in the pipeline 402 can be utilized to generate a unique template description 422, such as for each repetition (e.g., each of the N times repeated to generate different unique template descriptions). For instance, for any number of iterations, another of the animation template(s) 206 in the template/tag pair(s) 404 can be selected for the pipeline 402, such as for performing any of the operation(s) in the pipeline 402. In such an instance or another instance, another set of the tag(s) 208 in the template/tag pair(s) 404 can be utilized as part of the pipeline 402, for any of the operation(s) in the pipeline 402

The operation(s) in the pipeline 402 can be utilized to generate one or more template descriptions, such as K*N template descriptions 424. Template/tag pair(s) 404 can be processed to generate, for individual ones of K number of template/tag pair(s) 404, N number of natural language descriptions. For instance, N number of natural language descriptions can be generated for each of the K number of template/tag pair(s) 404, such as to generate the K*N template descriptions 424. In some cases, each of the K template/tag pair(s) 404 (e.g., including each of the corresponding tagged templates 216) can be utilized to generate N number of natural language descriptions, for all of the animation templates 206.

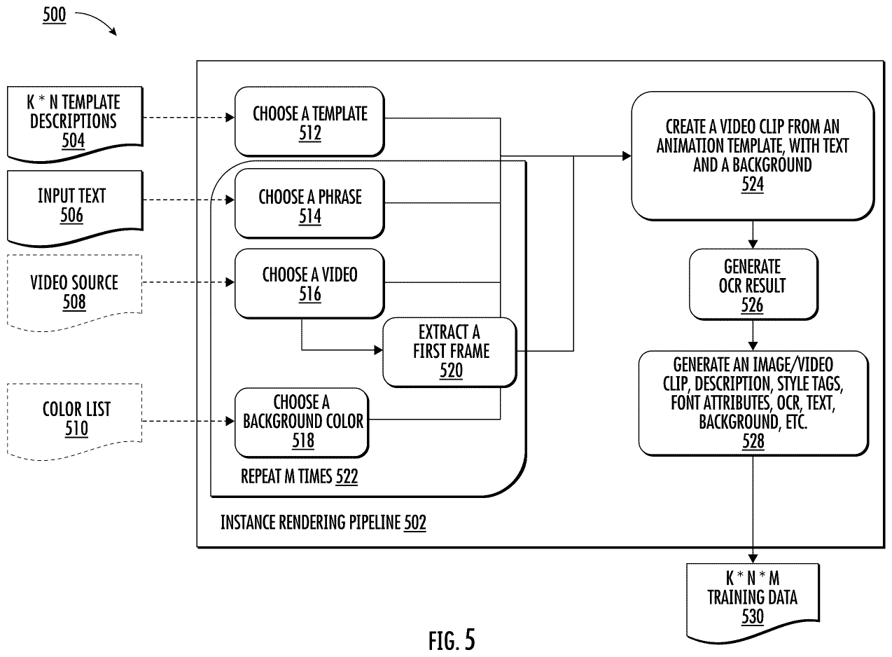

FIG. 5 depicts a block diagram of an example instance rendering pipeline in a synthetic data generation system 500 for graphical text stylization and animation according to example embodiments of the present disclosure. The synthetic data generation system (also referred to herein simply as “system”) 500 can utilize the instance rendering pipeline, such as an instance rendering pipeline 502 for graphical text stylization and animation. In some examples, the synthetic data generation system 500 can be utilized to implement various portions of the synthetic data generation system(s) 100 and 200, as discussed above with reference to FIGS. 1 and 2. In those or other examples, the instance rendering pipeline (also referred to herein simply as “pipeline”) 502 may be implemented utilizing the machine-learned model(s) managed by the server(s) 226.

The pipeline 502 can be utilized to manage (e.g., receive, identify, determine, process, etc.) various types of data, such as one or more template descriptions 504, which can include the K*N template descriptions 424, as discussed above with reference to FIG. 4. The data managed by the pipeline 502 can include input text 506 from one or more portions of input text, a video source 508 from one or more video sources, and a color list 510 from one or more color lists. In some examples, the input text 506 can include any text from any text corpus (e.g., Moby Dick, Don Quixote, the Mahābhārata, etc., or any combination thereof), which can be provided by one or more servers (e.g., any of the server(s) 202, 212, and/or 226, as discussed above with reference to FIG. 2, any other servers, or any combination thereof). For instance, the input text 506 can include one or more portions of text (e.g., one or more text corpuses) received from a service provider (e.g., via any of the server(s) 202, 212, and/or 226), one or more portions of text received from a customer and/or client (e.g., via any number of the other servers), one or more portions of text received from any other party/server/device (e.g., via any number of the other servers), or any combination thereof. In various examples, the video source 508 can include any of the video source(s), which can be provided by the same or different server(s). In those or other examples, the color list 510 can include any of the color list(s), which can be provided by the same or different server(s).

At least one of the operation(s) in the pipeline 402 can be performed to choose the template 512, such as to select any of the tagged template(s) 216. The selected tagged template(s) 216 may include the tagged template(s) 216 corresponding to the animation template 206 selected via the at least one operation performed to choose the template 206, as discussed above with reference to FIG. 2. However, in alternative examples, another, different, template from among the animation template(s) 206 and/or the tagged template(s) 216 may be selected via the at least one operation to choose the template 512.

At least one of the operation(s) in the pipeline 402 can be performed to choose a phrase 514. A phrase (e.g., which can represent at least one phrase) can be selected from the input text 506 (e.g., which may represent at least one portion of input text). The at least one operation to choose the phrase 514 can include selecting a random phrase from the input text 506. In various cases, the selected phrase can be utilized as any of the input source-based text 220, as discussed above with reference to FIG. 2.

At least one of the operation(s) in the pipeline 402 can be performed to choose a phrase 516. The video source 508 (e.g., including video media content usable to present one or more videos) can be identified to select a video (e.g., which may represent at least one video, and/or at least one image, such as a still image or a dynamic image) from among the video source 508. The at least one operation to choose the video 516 can include selecting a random video from among the video source 508. In various cases, the selected video can be utilized as any of the background/color(s)/image(s)/video(s) 222, as discussed above with reference to FIG. 2.

At least one of the operation(s) in the pipeline 402 can be performed to choose a background color 518. The color list 510 can be identified to select background color (e.g., which may represent at least one background color) from among the color list 510. The at least one operation to choose the background color 518 can include selecting a random background color from among the color list 510. In various cases, the selected background color can be utilized as any of the background/color(s)/image(s)/video(s) 222.

At least one of the operation(s) in the pipeline 402 can be performed to extract a first frame 520. In some examples, a first frame can be extracted from the selected video. In various examples, any number of frames can be extracted. In those or other examples, any frame initially extracted can include any single frame (e.g., the first frame 520, a middle frame, a selected frame, a last frame, etc.).

At least one of the operation(s) in the pipeline 402 can be performed to repeat M (e.g., a positive whole number M) times 522, any of the operation(s) to perform one or more actions 512, 514, 516, 518, and/or 520. For instance, the operation(s) in the pipeline 402 can be performed to repeat the operations to choose the template 512, choose the phrase 514, choose the video 516, choose the background color 518, and extract the first frame 520. The actions 512, 514, 516, 518, and 520 can be repeated M times, which may yield M unique renderings of each of the K*N template descriptions 504.

At least one of the operation(s) in the pipeline 402 can be performed to create a video clip from an animation template, with text and a background 524. In some examples, a video clip can be created using the template (e.g., the selected tagged template 216) selected via the at least one operation performed to choose the template 512. In those or other examples, the video clip can be created using text, such as the phrase selected via the at least one operation performed to choose the phrase 514. In those or other examples, the video clip can be created using, as a background, the video (e.g., or the image) selected via the at least one operation performed to choose the video 514. Alternatively, the video clip can be created using, as the background, the background color selected via the at least one operation performed to choose the background color 518.

At least one of the operation(s) in the pipeline 402 can be performed to generate an OCR result 526. In some examples, the at least one operation can be utilized to manage (e.g., identify, determine, generate, modify, delete, etc.) an OCR result. The OCR result can be generated by performing OCR on the video clip (e.g., the OCR result can be generated from a rendered image, a rendered video, such as the video clip, and/or any combination of rendered data of any type). A result of the OCR being performed can include text corresponding to the text (e.g., the selected phrase) in the video clip. In various examples, for instance with respect to the performing of the OCR, the result of the OCR can include text (e.g., initial text, original text, etc., or any combination thereof) that was initially included in any image and/or video (e.g., an image and/or video of an animation template 206, an image and/or video of a tagged template 216, an image and/or video of a next template 230, an image and/or video of any template in the template, text, and background-based rendered image/video 232, or any combination thereof), any other image and/or video (e.g., any image and/or video used in the pipeline(s) 402 and/or 502), or any combination thereof.

At least one of the operation(s) in the pipeline 402 can be performed repeatedly to generate, any number of times, an image/video clip, description, style tags, font attributes, OCR, text, background, etc., 528. For example, in response to a command (e.g., provided in and/or along with a template description 504), such as “put ‘Moby Dick’ on the video within coordinates “XX,” and with colors “XX,” etc., the pipeline 402 can generate a video, included in the image/video clip, description, style tags, font attributes, OCR, text, background, etc., 528. The video in the image/video clip, description, style tags, font attributes, OCR, text, background, etc., 528 can be generated to include the text “Moby Dick” with the coordinates “XX,” and with the colors “XX.” The pipeline 402 can be utilized to distinguish text (e.g., the graphical text) being put on the background from text that is originally in the background (e.g., words on street signs, t-shirts, storefronts, game playfields, etc.).

Individual ones (e.g., individual instances) of an image/video clip, description, style tags, font attributes, OCR, text, background, etc., (e.g., an image/video clip, description, style tags, font attributes, OCR, text, background, etc., 528) can be different from any other one (e.g., instance) of an image/video clip, description, style tags, font attributes, OCR, text, background, etc. For example, any instance (e.g., any image/video clip, description, style tags, font attributes, OCR, text, background, etc., 528) can include a plurality of of tags that is different from a plurality of of tags in another instance (e.g., another image/video clip, description, style tags, font attributes, OCR, text, background, etc., 528). In such an example or another example, for a given template (e.g., a template, such as an animation template corresponding to K=1, which possibly has N=6 attribute types), a portion of a corresponding natural language description (e.g., a portion of a description in an image/video clip, description, style tags, font attributes, OCR, text, background, etc., 528) may mention a color, a motion, a font, etc. In such an example or another example, for the animation template corresponding to K=1, a portion of a corresponding different natural language description (e.g., a portion of a different description in a different image/video clip, description, style tags, font attributes, OCR, text, background, etc., 528) may mention another color, another motion, another font, etc. Additionally or alternatively, any color in any description may be expressed as an absolute (“green”), may be expressed modally (“calming”), etc., or any combination thereof.

In some examples, the at least one operation performed for each of at least one of one or more actions 512, 514, 516, 518, 520, 524, and/or 526 can be sequenced (e.g., repeated) for individual ones of the K*N template descriptions 504. For instance, for individual ones of the K*N template descriptions 504, the at least one operation performed for each of at least one of the action(s) 512, 514, 516, 518, 520, 524, and/or 526 can be sequenced (e.g., repeated) M (e.g., a positive whole number M) times. In such an instance, for examples with the at least one operation performed for each of at least one of the action(s) 512, 514, 516, 518, 520, 524, and/or 526 being sequenced (e.g., repeated), a result of the action(s) 512, 514, 516, 518, 520, 524, and/or 526 may be managed (e.g., identified, determined, generated, stored, modified, deleted, etc.) as training data.

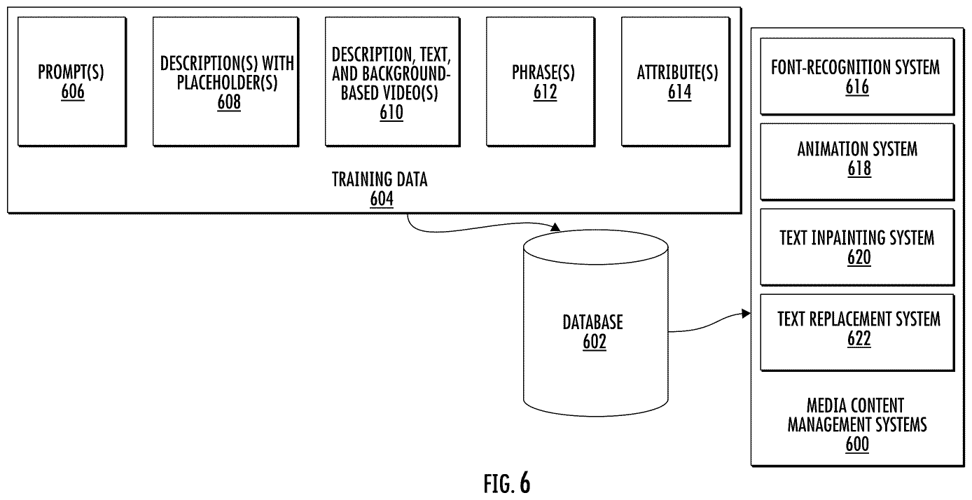

Training data, such as K*N*M training data 530, generated via the pipeline 502 can include various types of data. In some examples, the training data 530 can include some or all of the results of any of the actions 512-528. The training data 530 can include the video clip, the corresponding subset of tag(s) 208, the corresponding attribute(s) (e.g., the corresponding font attribute(s)), the corresponding OCR result, the corresponding text (e.g., the corresponding phrase), and/or the corresponding background (e.g., the corresponding background video, image, or color). The training data 530 can be stored via a table in a database (e.g., the database 602, as discussed below with reference to FIG. 6).

FIG. 6 depicts a block diagram of example training data collected from a synthetic data generation system for graphical text stylization and animation, the training data being usable by media content management systems 600 according to example embodiments of the present disclosure. In some examples, the synthetic data generation system 600 can be utilized to store database data, via a database 602 and in one or more servers (e.g., any of the server(s) 202, 212, and/or 226, as discussed above with reference to FIG. 2, any other servers, or any combination thereof). The database data can include the training data, such as training data 604 (e.g., the training data 604 being stored in the database 602 can be identified as the database data). The training data 604 may be implemented by the training data 228, as discussed above with reference to FIG. 2.

The training data 604 can include various data generated via the pipelines 402 and 502. In some examples, the training data 604 can include one or more prompts 606 (e.g., the prompt(s) 210, as discussed above with reference to FIG. 2). In those or other examples, the training data 604 can include one or more descriptions with one or more placeholders 608 (e.g., the description(s) 218, as discussed above with reference to FIG. 2). In those or other examples, the training data 604 can include one or more description, text, and background-based videos 610 (e.g., the video clip(s) generated via the action(s) 524, as discussed above with reference to FIG. 5). In those or other examples, the training data 604 can include one or more video phrases 612 (e.g., the phrase(s) generated via the action(s) 514, as discussed above with reference to FIG. 5). In those or other examples, the training data 604 can include one or more attributes 614 (e.g., the attribute(s) with which the tag(s) 208 are associated, as discussed above with reference to FIG. 2) (e.g., which may also represent the tag(s) 208). In those or other examples, the training data 604 can include any other data generated via the pipelines 402 and 502, or any combination thereof.

Any of the training data 604 can be accessed, utilized, obtained, etc., by at least one of the media content management systems 600. The media content management systems 600 can include a font-recognition system 616 utilized to perform font recognition of videos/images. The media content management systems 600 can include an animation system 618 capable of performing animation of videos/images and/or graphical text therein. The media content management systems 600 can include a text inpainting system 620 capable of performing inpainting processes for videos/images (e.g., restoring of missing and/or damaged parts of videos/images). The media content management systems 600 can include a text replacement system 622 capable of replacing graphical text in videos/images.

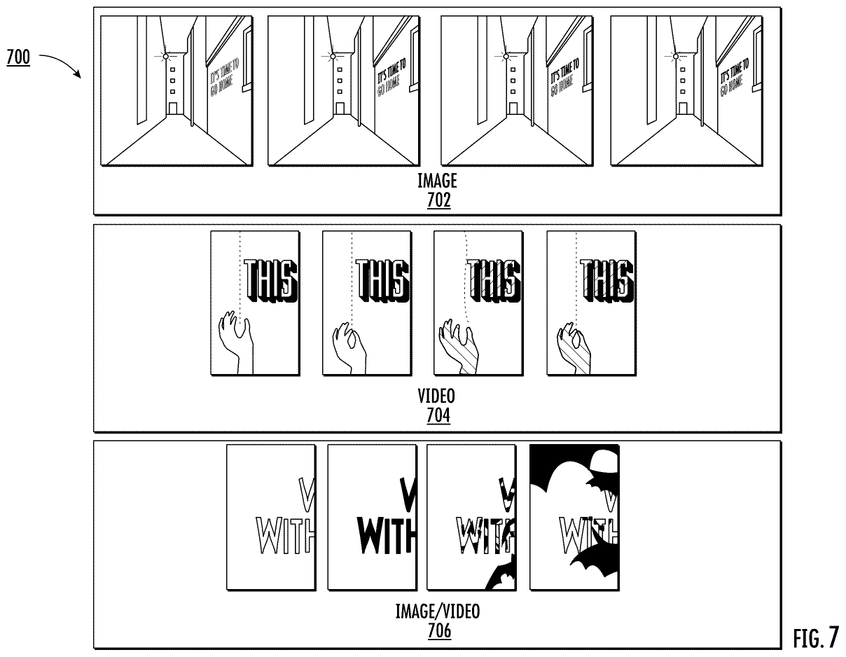

FIG. 7 depicts example images 700 processed by a synthetic data generation system for graphical text stylization and animation according to example embodiments of the present disclosure. In some examples, the synthetic data generation system (or “system”) can be implemented by the system(s) 100, 200, 400, and 500, as discussed above with reference to FIGS. 1, 2, 4, and 5, one or more other systems, or any combination thereof.

The images 700 can include an image 702 with graphical text portrayed by a light fixture (e.g., a neon light) on a side of a building. The light fixture may be shaped to form letters of the graphical text to spell out one or more words, one or more phrases, one or more sentences, one or more sayings, etc., (e.g., a sentence “IT'S TIME TO GO HOME”). Portions of the neon light lit up sequentially may be utilized to illuminate corresponding portions of the sentence. In some examples, the image 702 may be utilized as an animation template (e.g., an animation template 206, as discussed above with reference to FIG. 2).

The server(s) 212 and 226 can be utilized to generate training data (e.g., the training data 228 and 604, as discussed above with reference to FIGS. 2 and 6) utilizing the image 702. In some examples, an image on which the neon light is overlaid may be included as a background image (e.g., the image identified by the action to choose video/image 516, as discussed above with reference to FIG. 5) in the instance rendering pipeline 502, as discussed above with reference to FIG. 5. In those or other examples the sentence portrayed by the graphical text spelled out by the neon light may be utilized as the phrase (e.g., the phrase identified by the action to choose the phrase 514, as discussed above with reference to FIG. 5) in the instance rendering pipeline 502, as discussed above with reference to FIG. 5.

The images 700 can include a video 704 with graphical text portrayed by lettering superimposed on a background color (e.g., forest green). The video 704 may include a hand moving to grab a chain, pull the chain down to change a color of the graphical text from forest green to pink, release the chain, moving again to grab the chain, pulling the chain down again to change a color of the graphical text from pink (e.g., back to forest green), and so on in a circular pattern. In some cases, any color (e.g., an initial color) can be changed to any color (e.g., another color, a next color, etc.) based on activation of the chain (e.g., based on the chain being pulled). A sequence of colors can be repeated for any number of pulls of the chain (e.g., until the number is above a threshold). Any number of sequences of colors can be repeated. Any number of sequences of colors can be used once or used a predetermined number of times, sequentially or not sequentially. Any pattern of any number of colors can be repeated and/or used a predetermined number of times. Colors can change randomly according to the chain being pulled each time, after a preset number of pulls of the chain, after a randomly selected number of pulls, etc., or any combination thereof. Colors can be selected and/or predetermined. Any sequence and/or individual selection of a color can be selected and/or predetermined.

The lettering of the graphical text may be shaped to form letters of the graphical text to spell out one or more words, one or more phrases, one or more sentences, one or more sayings, etc., (e.g., a word “THIS”). In some examples, the video 704 may be utilized as an animation template (e.g., an animation template 206). In some examples, a video with the background and hand, on which the graphical text is superimposed, may be included as a background video (e.g., the video identified by the action to choose video/image 516) in the instance rendering pipeline 502. In those or other examples the word portrayed in the graphical text superimposed on the forest green background may be utilized as the phrase (e.g., the phrase identified by the action to choose the phrase 514) in the instance rendering pipeline 502.

The images 700 can include an image/video 706 with graphical text portrayed by lettering superimposed on a background color (e.g., dark green). The image/video 706 may include the lettering quivering in orange, the lettering quivering in black (e.g., with some orange portions/slivers), the lettering quivering in orange and black (e.g., in various proportions/distributions with respect to portions in orange or black) and with bats emerging therefrom, the lettering quivering in orange (e.g., with some black portions) and with bats flying in a foreground, the letters quivering in orange again, and so on (e.g., such as in a circular pattern). The lettering may be shaped to form letters of the graphical text to spell out one or more words, one or more phrases, one or more sentences, one or more sayings, etc., (e.g., letters/words “V WITH”). In some examples, the video 706 may be utilized as an animation template (e.g., an animation template 206).

In some examples, the image/video 706 may include a video with the dark green background, with bats, and with graphical text. The video may include the dark green background interwoven with the graphical text (e.g., lettering that quivers) and with bats that emerge from the graphical text. The image/video 706 may be identified as the video by the action to choose video/image 516) in the instance rendering pipeline 502. Alternatively, the image/video 706 may include an image with the dark green background and with graphical text. The dark green background may be interwoven with graphical text (e.g., lettering that quivers and that has bats emerging therefrom). The image/video 706 may be identified as the image by the action to choose video/image 516) in the instance rendering pipeline 502. In those or other examples the letters/words portrayed in the graphical text interwoven in the image/video 706 may be utilized as the phrase (e.g., the phrase identified by the action to choose the phrase 514) in the instance rendering pipeline 502.

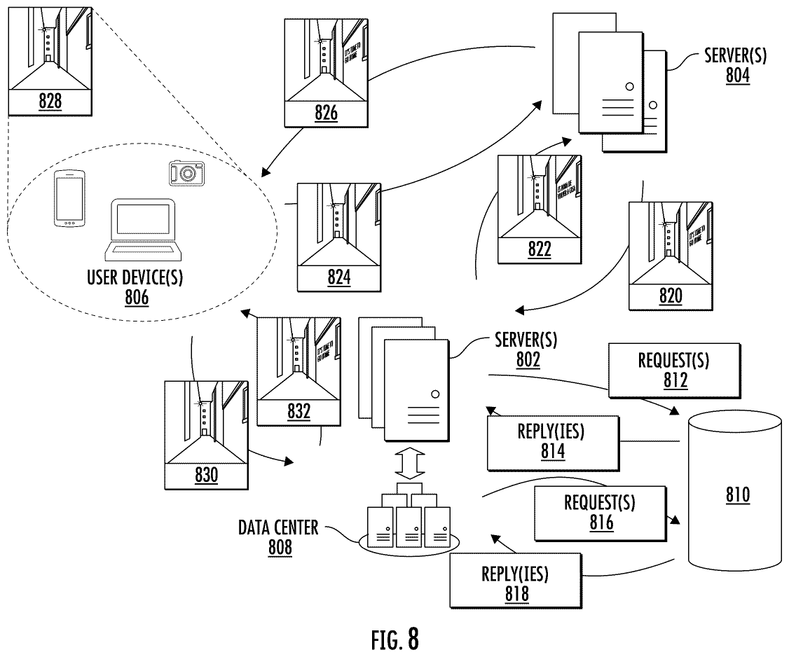

FIG. 8 depicts an example environment 800 with one or more synthetic data generation servers 802, one or more client servers 804, one or more user devices 806, the synthetic data generation system 802 being utilized for graphical text stylization and animation according to example embodiments of the present disclosure. A synthetic data generation system that includes the synthetic data generation server(s) 802 can be implemented by the system(s) 100, 200, 400, 500, 600, and/or 700, as discussed above with reference to FIGS. 1, 2, and 4-7. The synthetic data generation server(s) (also referred to herein simply as “server(s)”) 802 can include one or more servers (e.g., any of the server(s) 202, 212, and/or 226, as discussed above with reference to FIG. 2, any other servers, or any combination thereof). In some examples, any of the server(s) 802, the server(s) 804, and/or one or more other server(s) in the environment 800, can include at least one media content management server (e.g., at least one server in any of the system(s) 616-622 in the media content management systems 600).

The environment 800 can include a data center 808 and a database 810 (e.g., the database 602, as discussed above with reference to FIG. 6). Any combination of the synthetic data generation server(s) 802, the data center 808 and the database 810 can be communicatively coupled to one another.

The synthetic data generation server(s) 802 and/or the data center 808 can exchange one or more communications with one another, and/or with the database 808. The communication(s) can include one or more requests 812 from the server(s) 802 and to the database 810. Any of the request(s) 812 can be utilized by the server(s) 802 to store training data (e.g., the training data 228, 530, and/or 604, as discussed above with reference to FIGS. 2, 5, and 6) in the database 810. Any of the request(s) 812 can be utilized by the server(s) 802 to request, store, and/or obtain the training data from the database 810. Similar requests, such as one or more requests 816, can be exchanged between the data center 808 and the database 810 for the data center 808 to request, store, and/or obtain the training data. For example, the training data can be managed (e.g., identified, determined, generated, modified, stored, moved, deleted, etc.) by the server(s) 802 and/or the data center 808.

The communication(s) can include one or more replies 814 from the database 810 and to the server(s) 802. The reply(ies) 814 can be utilized by the server(s) 802 to receive the training data from the database 810. Similar replies, such as one or more replies 818, can be exchanged between the data center 808 and the database 810 for the data center 808 to receive the training data.

The synthetic data generation server(s) 802 and/or the client server(s) (also referred to herein simply as “server(s)”) 804 can exchange one or more communications with one another, and/or with the user device(s) 806. For example, one or more communications exchanged between the synthetic data generation server(s) 802 and the client server(s) 804 can include one or more requests, possibly with media content 820. The request(s) including the media content 820 can be transmitted by the server(s) 804 and to the server(s) 802. The request(s) with the media content 820 can include an image or a video as the media content 820.

The request(s) with the media content 820 that has graphical text (e.g., a sentence “IT'S TIME TO GO HOME”) in a language (e.g., English, Spanish, Chinese, etc.) can be utilized by the server(s) 804 to obtain an update image/video with different graphical text (e.g., a sentence “ES HORA DE VOLVER A CASA”) in another language (e.g., English, Spanish, Chinese, etc.). The server(s) 802 can process the media content 820 to replace the graphical text (e.g., initial graphical text) with updated graphical text that is different from the initial graphical text, while preserving all characteristics of the media content 820, including the graphical text (e.g., graphical text motion, graphical text animation color, graphical text font color, graphical text font attributes, graphical text emotion, etc., or any combination thereof). The server(s) 802 can process the media content 820 using a machine-learned model being trained with the training data (e.g., stored in the database 810). In some examples, the server(s) 802

The communication(s) exchanged between the server(s) 802 and the server(s) 804 can include one or more replies, possibly with media content 822. The reply(ies) including the media content 822 can be transmitted by the server(s) 802 and to server(s) 804. The reply(ies) with the media content 822 can include, as the media content 822, an updated image or an updated video. The server(s) 802, being utilized to perform one or more operations of the text replacement system 622, can generate the media content 822 based on the media content 820. The media content 822 can include the updated graphical text.

The communication(s) exchanged between the server(s) 802 and the server(s) 804 may be utilized for any operations, such as one or more operations associated with any of the media content management systems 600 (e.g., the system(s) 616-622). For example, the server(s) 804 can request font recognition of videos/images and/or graphical text therein, animation of videos/images and/or graphical text therein, restoring of missing and/or damaged parts of videos/images, replacing graphical text in videos/images (e.g., similarly as discussed above for the media content 820), various other operations, or any combination thereof.

The communication(s) exchanged between the server(s) 804 and the user device(s) 806 may be utilized for any operations, such as one or more operations associated with any of the media content management systems 600 (e.g., the system(s) 616-622). For example, the user device(s) 806 can transmit one or more requests with media content 824. The media content 824 may include, for example, no images/video and/or graphical text. The user device(s) 806 can request, via the request(s) with the media content 824, font recognition of videos/images and/or graphical text therein, animation of videos/images and/or graphical text therein, restoring of missing and/or damaged parts of videos/images, various other operations, or any combination thereof. The server(s) 804 may provide one or more responses with media content 826 that has updated images/videos with graphical text.

Various servers may perform one or more operations based on the request(s) with the media content 824. The operation(s) to generate the media content 826 based on the request(s) with the media content 824 may be performed by the server(s) 802 and/or the data center 808 (e.g., based on the request(s) being transmitted/related by the server(s) 804 and to the server(s) 802 and/or the data center 808). The server(s) 802 and/or the data center 808 may transmit one or more replies with the media content 826 to the server(s) 804. The reply(ies) with the media content 826 may be transmitted/relayed/routed by the server(s) 804 to the user device(s) 806.

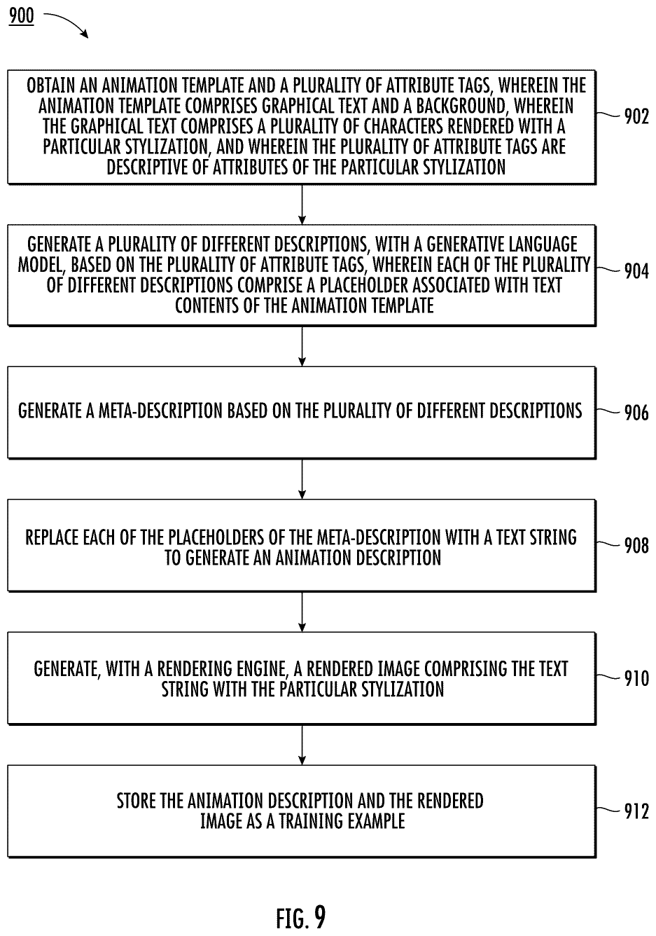

FIG. 9 depicts a flow chart diagram illustrating an example method 900 to perform description generation of graphical text and generation of rendered images with text strings having particular stylization according to example implementations of aspects of the present disclosure. Although FIG. 9 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, a computing system can obtain an animation template and a plurality of attribute tags, wherein the animation template comprises graphical text and a background, wherein the graphical text comprises a plurality of characters rendered with a particular stylization, and wherein the plurality of attributes tags are descriptive of attributes of the particular stylization. The animation template can include an animation template 206, which can include the graphical text and the background. The animation template 206 can be processed along with the plurality of attribute tags. The plurality of attribute tags can include a set of tags 208 corresponding to the animation template 206. The animation template 206 and the set of tags 208 can be processed to generate a set of prompts 210 corresponding to the animation template 206.

At 904, the computing system can generate a plurality of different descriptions, with a generative language model, based on the plurality of attribute tags, wherein each of the plurality of different descriptions comprise a placeholder associated with text contents of the animation template. A machine-learned model managed by the server(s) 212 can be processed ass the generated language model. The different descriptions can include a set of descriptions 218. Each of the set of descriptions 218 that are different can include the placeholder associated with the text contents. The text contents can include graphical text overlaid on other portions of the animation template 206 (e.g., an image, a video, a background color, etc.). The plurality of descriptions can be in the template descriptions 424.

At 906, the computing system can generate a meta-description based on the plurality of different descriptions. The meta-description can be included in at least one meta-description utilized to generate at least one corresponding natural language descriptions 224. In various cases, the at least one meta-description can include at least one corresponding natural language descriptions 224.

At 908, the computing system can replace each of the placeholders of the meta-description with a text string to generate an animation description. For example, the animation description can include a natural language description (e.g., a natural language description 224). The animation description being a natural language description 224 can include the text string in each placeholder of the meta-description.

At 910, the computing system can generate, with a rendering engine, a rendered image comprising the text string with the particular stylization. A machine-learned model (e.g., managed by server(s) 226), such as the rendering engine, can be utilized to generate the rendered image (such as a template, text, and background-based rendered image/video 232) with the string and with the particular stylization. The template, text, and background-based rendered image/video 232.

At 910, the computing system can store the animation description and the rendered image as a training example. The animation description (e.g., the natural language description 224) and the rendered image (e.g., the background-based rendered image/video 232) can be stored in the training data 228, as the training example.

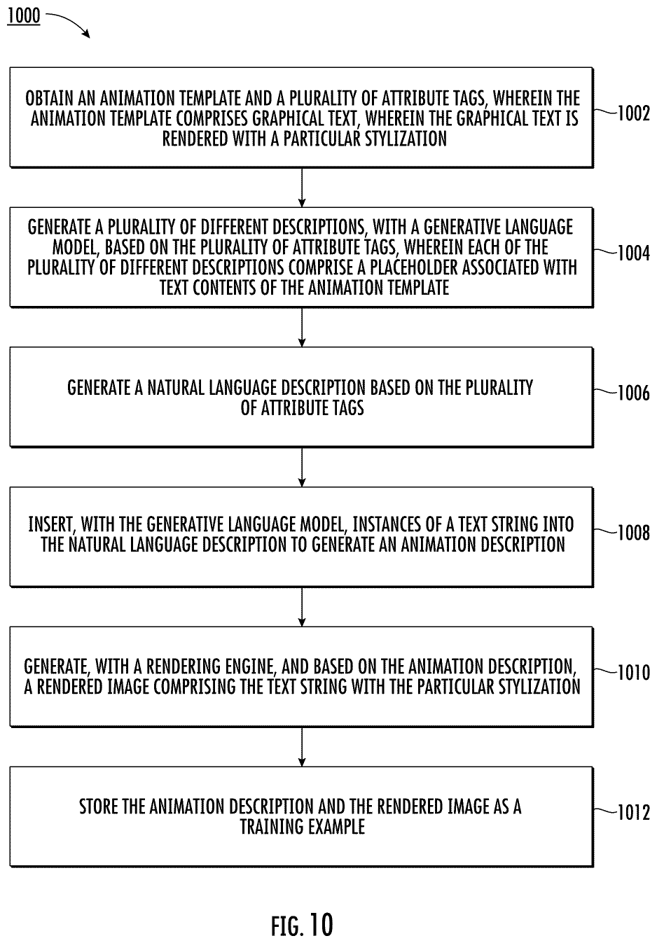

FIG. 10 depicts a flow chart diagram illustrating an example method 1000 to perform description generation of graphical text and generation of rendered images with text strings having particular stylization according to example implementations of aspects of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002, a computing system can obtain an animation template and a plurality of attribute tags, wherein the animation template comprises graphical text, wherein the graphical text is rendered with a particular stylization. The animation template can include an animation template 206 (e.g., one of the template/tag pair(s) 404). The template/tag pair 404 with the animation template can be selected as the template via an operation to choose the template 406.

At 1004, the computing system can generate a plurality of different descriptions, with a generative language model, based on the plurality of attribute tags, wherein each of the plurality of different descriptions comprise a placeholder associated with text contents of the animation template. The plurality of descriptions that are different can be in a plurality of descriptions (e.g., a set of descriptions) 218. The plurality of descriptions can be in the template descriptions 424. The subset of tags 208 can be selected from among the set of tags 208 corresponding to the animation template 206. Alternatively, the subset of tags 208 can be selected from among any of the tags 208.

At 1006, the computing system can generate a natural language description based on the plurality of attribute tags. The natural language description can be a natural language description 224 and/or a natural language description 504.

At 1008, the computing system can insert, with the generative language model, instances of a text string into the natural language description to generate an animation description. A machine-learned model (e.g., managed by server(s) 226), such as the generative language model, can be utilized to the instances of the text string into the natural language description to generate the animation description (e.g., a rendering of the template description 504). The instances of the text string can include the phrase selected via an operation to choose the phrase 514.

At 1010, the computing system can generate, with a rendering engine, and based on the animation description, a rendered image comprising the text string with the particular stylization. For example, the rendered image can be a video clip generated via an operation to create the video clip 524.

At 1012, the computing system can store the animation description and the rendered image as a training example. The animation description can be stored with the rendered images as the training example in the training data 530.

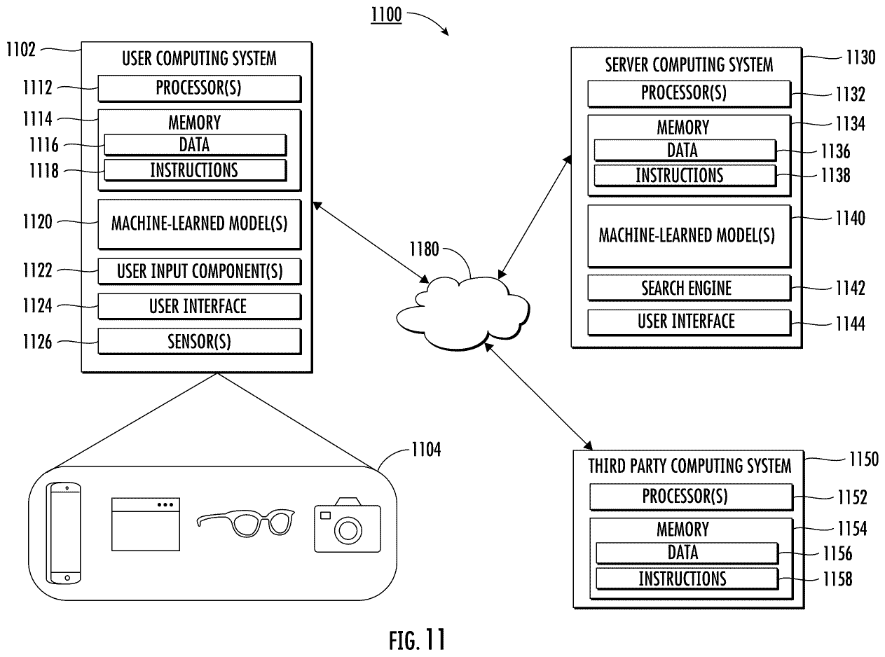

FIG. 11 depicts a block diagram of an example computing system 1100 that performs graphical text stylization and animation according to example embodiments of the present disclosure. The system 1100 includes a user computing system 1102, a server computing system 1130, and/or a third party computing system 1150 that are communicatively coupled over a network 1180.

The user computing system 1102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 1102 includes one or more processors 1112 and a memory 1114. The one or more processors 1112 can be any suitable processing device (e.g., a processor core, a microprocessor, an ASIC, a FPGA, a controller, a microcontroller, etc.) and can be one processor or a plurality of processors that are operatively connected. The memory 1114 can include one or more non-transitory computer-readable storage mediums, such as RAM, ROM, EEPROM, EPROM, flash memory devices, magnetic disks, etc., and combinations thereof. The memory 1114 can store data 1116 and instructions 1118 which are executed by the processor 1112 to cause the user computing system 1102 to perform operations.

In some implementations, the user computing system 1102 can store or include one or more machine-learned models 1120. For example, the machine-learned models 1120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 1120 can be received from the server computing system 1130 over network 1180, stored in the user computing device memory 1114, and then used or otherwise implemented by the one or more processors 1112. In some implementations, the user computing system 1102 can implement multiple parallel instances of a single machine-learned model 1120 (e.g., to perform parallel machine-learned model processing across multiple instances of input data and/or detected features).

More particularly, the one or more machine-learned models 1120 may include one or more detection models, one or more classification models, one or more segmentation models, one or more augmentation models, one or more generative models, one or more natural language processing models, one or more optical character recognition models, and/or one or more other machine-learned models. The one or more machine-learned models 1120 can include one or more transformer models. The one or more machine-learned models 1120 may include one or more neural radiance field models, one or more diffusion models, and/or one or more autoregressive language models.

The one or more machine-learned models 1120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 1120 can process image data, text data, audio data, and/or latent encoding data to generate output data that can include image data, text data, audio data, and/or latent encoding data. The one or more machine-learned models 1120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, arXiv:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, images/videos with graphical text that has stylizations, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 1140 can be included in or otherwise stored and implemented by the server computing system 1130 that communicates with the user computing system 1102 according to a client-server relationship. For example, the machine-learned models 1140 can be implemented by the server computing system 1130 as a portion of a web service (e.g., a viewfinder service, a visual search service, an image processing service, an ambient computing service, and/or an overlay application service). Thus, one or more models 1120 can be stored and implemented at the user computing system 1102 and/or one or more models 1140 can be stored and implemented at the server computing system 1130.

The user computing system 1102 can also include one or more user input components 1122 that receive user input. For example, the user input component 1122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 1102 can store and/or provide one or more user interfaces 1124, which may be associated with one or more applications. The one or more user interfaces 1124 can be configured to receive inputs and/or provide data for display (e.g., image data, text data, audio data, one or more user interface elements, an augmented-reality experience, a virtual reality experience, and/or other data for display. The user interfaces 1124 may be associated with one or more other computing systems (e.g., server computing system 1130 and/or third party computing system 1150). The user interfaces 1124 can include a viewfinder interface, a search interface, a generative model interface, a social media interface, and/or a media content gallery interface.

The user computing system 1102 may include and/or receive data from one or more sensors 1126. The one or more sensors 1126 may be housed in a housing component that houses the one or more processors 1112, the memory 1114, and/or one or more hardware components, which may store, and/or cause to perform, one or more software packets. The one or more sensors 1126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 1102 may include, and/or be part of, a user computing device 1104. The user computing device 1104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 1104. For example, a camera of a smartphone may be utilized to capture image data descriptive of the environment, and/or an overlay application of the user computing device 1104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 1130 includes one or more processors 1132 and a memory 1134. The one or more processors 1132 can be any suitable processing device (e.g., a processor core, a microprocessor, an ASIC, a FPGA, a controller, a microcontroller, etc.) and can be one processor or a plurality of processors that are operatively connected. The memory 1134 can include one or more non-transitory computer-readable storage mediums, such as RAM, ROM, EEPROM, EPROM, flash memory devices, magnetic disks, etc., and combinations thereof. The memory 1134 can store data 1136 and instructions 1138 which are executed by the processor 1132 to cause the server computing system 1130 to perform operations.

In some implementations, the server computing system 1130 includes or is otherwise implemented by one or more server computing devices. In instances in which the server computing system 1130 includes plural server computing devices, such server computing devices can operate according to sequential computing architectures, parallel computing architectures, or some combination thereof.

As described above, the server computing system 1130 can store or otherwise include one or more machine-learned models 1140. For example, the models 1140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1140 are discussed with reference to FIG. 11B.

Additionally and/or alternatively, the server computing system 1130 can include and/or be communicatively connected with a search engine 1142 that may be utilized to crawl one or more databases (and/or resources). The search engine 1142 can process data from the user computing system 1102, the server computing system 1130, and/or the third party computing system 1150 to determine one or more search results associated with the input data. The search engine 1142 may perform term based search, label based search, Boolean based searches, image search, embedding based search (e.g., nearest neighbor search), multimodal search, and/or one or more other search techniques.

The server computing system 1130 may store and/or provide one or more user interfaces 1144 for obtaining input data and/or providing output data to one or more users. The one or more user interfaces 1144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 1102 and/or the server computing system 1130 can train the models 1120 and/or 1140 via interaction with the third party computing system 1150 that is communicatively coupled over the network 1180. The third party computing system 1150 can be separate from the server computing system 1130 or can be a portion of the server computing system 1130. Alternatively and/or additionally, the third party computing system 1150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

In some implementations, the computing system 1100 may utilize training data (e.g., the training data 530, as discussed above with respect to FIG. 5) for training the one or more machine-learned models (1120 and/or 1140) for downstream tasks. The training data 530 can include image/video clips, descriptions, style tags (e.g., attribute tags associated with font styles of graphical text), font attributes, OCS results, text (e.g., text in phrases utilized for graphical text), backgrounds, etc.

The training data 530 may be generated based on a template-description generation pipeline 402. Alternatively or additionally, the training data 530 may be generated based on an instance rendering pipeline 502.

The third party computing system 1150 can include one or more processors 1152 and a memory 1154. The one or more processors 1152 can be any suitable processing device (e.g., a processor core, a microprocessor, an ASIC, a FPGA, a controller, a microcontroller, etc.) and can be one processor or a plurality of processors that are operatively connected. The memory 1154 can include one or more non-transitory computer-readable storage mediums, such as RAM, ROM, EEPROM, EPROM, flash memory devices, magnetic disks, etc., and combinations thereof. The memory 1154 can store data 1156 and instructions 1158 which are executed by the processor 1152 to cause the third party computing system 1150 to perform operations. In some implementations, the third party computing system 1150 includes or is otherwise implemented by one or more server computing devices.

The network 1180 can be any type of communications network, such as a local area network (e.g., intranet), wide area network (e.g., Internet), or some combination thereof and can include any number of wired or wireless links. In general, communication over the network 1180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, or images/videos with graphical text that has stylizations, etc.). As another example, the machine-learned model(s) can process the text or natural language data to generate a prediction output.

In some implementations, the input to the machine-learned model(s) of the present disclosure can be speech data and/or images/videos with graphical text that has stylizations. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, images/videos with graphical text that has stylizations, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 1120 and/or 1140) can be configured to output content (e.g., images/videos with graphical text that has stylizations) generated in view of one or more inputs. For instance, the inputs can be or otherwise represent data of one or more modalities that encodes context for generating additional content.

In some implementations, the task can be a text completion task. The machine-learned models can be configured to process the inputs that represent textual data, and/or images/videos with graphical text that has stylizations, and to generate the outputs that represent images/videos with graphical text that has stylizations.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed), and/or images/videos with graphical text that has stylizations, and the machine-learned models can process the inputs to generate the outputs that represent images/videos with graphical text that has stylizations responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent images/videos with graphical text that has stylizations responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed), and/or images/videos with graphical text that has stylizations, and the machine-learned models can process the inputs to generate the outputs that represent images/videos with graphical text that has stylizations responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent images/videos with graphical text that has stylizations responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content, and/or that include images/videos with graphical text that has stylizations. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.), and/or that include images/videos with graphical text that has stylizations. The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 1102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 1100.

The central intelligence layer can communicate with a central device data layer. The central device data layer can be a centralized repository of data for the computing system 1100. The central device data layer may communicate with a number of other components of the computing device, such as, for example, one or more sensors, a context manager, a device state component, and/or additional components. In some implementations, the central device data layer can communicate with each device component using an API (e.g., a private API).

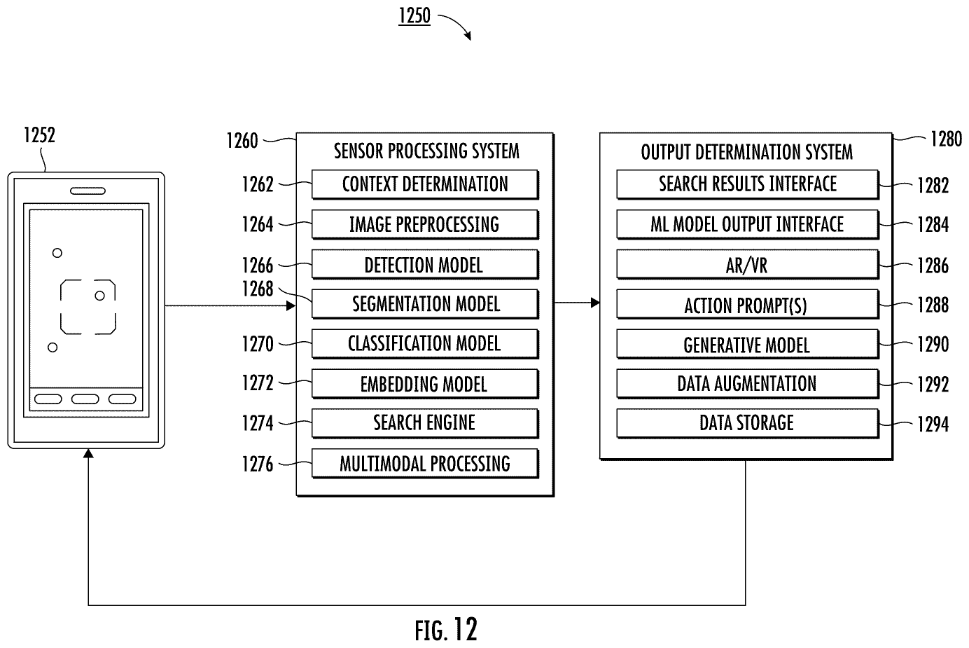

FIG. 12 depicts a block diagram of an example computing system 1250 that performs graphical text stylization and animation according to example embodiments of the present disclosure. In particular, the example computing system 1250 can include one or more computing devices 1252 that can be utilized to obtain, and/or generate, one or more datasets that can be processed by a sensor processing system 1260 and/or an output determination system 1280 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 1252 (e.g., one or more sensors in the computing device 1252). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 1252 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 1260. The sensor processing system 1260 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 1262, which may determine a context associated with one or more content items. The context determination block 1262 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 1260 may include an image preprocessing block 1264. The image preprocessing block 1264 may be utilized to adjust one or more values of an obtained and/or received image to prepare the image to be processed by one or more machine-learned models and/or one or more search engines 1274. The image preprocessing block 1264 may resize the image, adjust saturation values, adjust resolution, strip and/or add metadata, and/or perform one or more other operations.

In some implementations, the sensor processing system 1260 can include one or more machine-learned models, which may include a detection model 1266, a segmentation model 1268, a classification model 1270, an embedding model 1272, and/or one or more other machine-learned models. For example, the sensor processing system 1260 may include one or more detection models 1266 that can be utilized to detect particular features in the processed dataset. In particular, one or more images can be processed with the one or more detection models 1266 to generate one or more bounding boxes associated with detected features in the one or more images.

Additionally and/or alternatively, one or more segmentation models 1268 can be utilized to segment one or more portions of the dataset from the one or more datasets. For example, the one or more segmentation models 1268 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 1270 can be utilized to process image data, text data, audio data, latent encoding data, multimodal data, and/or other data to generate one or more classifications. The one or more classification models 1270 can include one or more image classification models, one or more object classification models, one or more text classification models, one or more audio classification models, and/or one or more other classification models. The one or more classification models 1270 can process data to determine one or more classifications.

In some implementations, data may be processed with one or more embedding models 1272 to generate one or more embeddings. For example, one or more images can be processed with the one or more embedding models 1272 to generate one or more image embeddings in an embedding space. The one or more image embeddings may be associated with one or more image features of the one or more images. In some implementations, the one or more embedding models 1272 may be configured to process multimodal data to generate multimodal embeddings. The one or more embeddings can be utilized for classification, search, and/or learning embedding space distributions.

The sensor processing system 1260 may include one or more search engines 1274 that can be utilized to perform one or more searches. The one or more search engines 1274 may crawl one or more databases (e.g., one or more local databases, one or more global databases, one or more private databases, one or more public databases, one or more specialized databases, and/or one or more general databases) to determine one or more search results. The one or more search engines 1274 may perform feature matching, text based search, embedding based search (e.g., k-nearest neighbor search), metadata based search, multimodal search, web resource search, image search, text search, and/or application search.

Additionally and/or alternatively, the sensor processing system 1260 may include one or more multimodal processing blocks 1276, which can be utilized to aid in the processing of multimodal data. The one or more multimodal processing blocks 1276 may include generating a multimodal query and/or a multimodal embedding to be processed by one or more machine-learned models and/or one or more search engines 1274.

The output(s) of the sensor processing system 1260 can then be processed with an output determination system 1280 to determine one or more outputs to provide to a user. The output determination system 1280 may include heuristic based determinations, machine-learned model based determinations, user selection based determinations, and/or context based determinations.

The output determination system 1280 may determine how and/or where to provide the one or more search results in a search results interface 1282. Additionally and/or alternatively, the output determination system 1280 may determine how and/or where to provide the one or more machine-learned model outputs in a machine-learned model output interface 1284. In some implementations, the one or more search results and/or the one or more machine-learned model outputs may be provided for display via one or more user interface elements. The one or more user interface elements may be overlayed over displayed data. For example, one or more detection indicators may be overlaid over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 1260 may be utilized to generate and/or provide an augmented-reality experience and/or a virtual-reality experience 1286. For example, the one or more obtained datasets may be processed to generate one or more augmented-reality rendering assets and/or one or more virtual-reality rendering assets, which can then be utilized to provide an augmented-reality experience and/or a virtual-reality experience 1286 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 1288 may be determined based on the output(s) of the sensor processing system 1260. For example, a search prompt, a purchase prompt, a generate prompt, a reservation prompt, a call prompt, a redirect prompt, and/or one or more other prompts may be determined to be associated with the output(s) of the sensor processing system 1260. The one or more action prompts 1288 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 1260 may be processed with one or more generative models 1290 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 1290 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 1290 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 1290 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 1290 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 1290 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human. A tuned vision language model (VLM) can be utilized to process image data (e.g., an image) to generate a description of the image. The description of the image can include a description of a stylization of text (e.g., graphical text in the image) based on tuning the vision language model on training data generated based on the processes discussed herein.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 1290 may be stored on-device and/or may be stored on a server computing system. In some implementations, the one or more generative models 1290 can perform on-device processing to determine suggested searches, suggested actions, and/or suggested prompts. The one or more generative models 1290 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 1290 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

The output determination system 1280 may process the one or more datasets and/or the output(s) of the sensor processing system 1260 with a data augmentation block 1292 to generate augmented data. For example, one or more images can be processed with the data augmentation block 1292 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 1260 may be stored based on a data storage block 1294 determination.

The output(s) of the output determination system 1280 can then be provided to a user via one or more output components of the user computing device 1252. For example, one or more user interface elements associated with the one or more outputs can be provided for display via a visual display of the user computing device 1252.

The processes may be performed iteratively and/or continuously. One or more user inputs to the provided user interface elements may condition and/or affect successive processing loops.

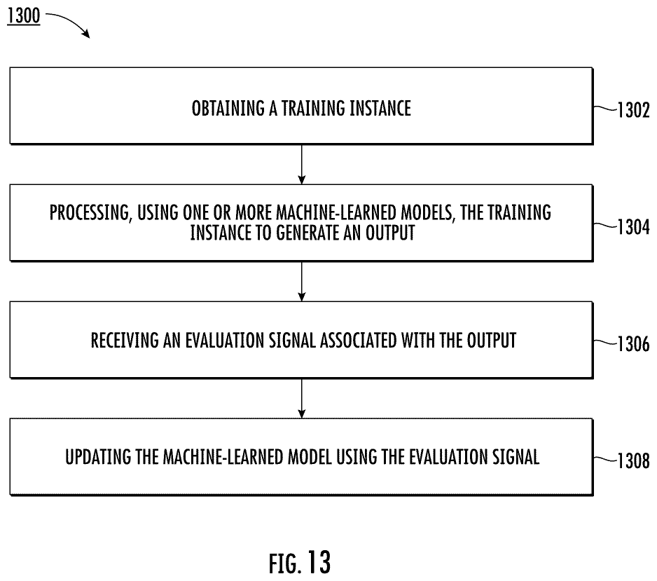

FIG. 13 depicts a flowchart of a method 1300 for training one or more machine-learned models according to aspects of the present disclosure. For instance, an example machine-learned model can include a {reference to claimed model(s)}

One or more portion(s) of example method 1300 can be implemented by a computing system that includes one or more computing devices such as, for example, computing systems described with reference to the other figures. Each respective portion of example method 1300 can be performed by any (or any combination) of one or more computing devices. Moreover, one or more portion(s) of example method 1300 can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of example method 1300 can be performed additionally, or alternatively, by other systems.

At 1302, example method 1300 can include obtaining a training instance. A set of training data can include a plurality of training instances divided between multiple datasets (e.g., a training dataset, a validation dataset, or testing dataset). A training instance can be labeled or unlabeled. Although referred to in example method 1300 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1304, example method 1300 can include processing, using one or more machine-learned models, the training instance to generate an output. The output can be directly obtained from the one or more machine-learned models or can be a downstream result of a chain of processing operations that includes an output of the one or more machine-learned models.

At 1306, example method 1300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1308, example method 1300 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1300 can include implementing a number of generalization techniques (e.g., weight decays, dropouts, etc.) to improve the generalization capability of the models being trained.

In some implementations, example method 1300 can be implemented for training a machine-learned model from an initialized state to a fully trained state (e.g., when the model exhibits a desired performance profile, such as based on accuracy, precision, recall, etc.).

In some implementations, example method 1300 can be implemented for particular stages of a training procedure. For instance, in some implementations, example method 1300 can be implemented for pre-training a machine-learned model. Pre-training can include, for instance, large-scale training over potentially noisy data to achieve a broad base of performance levels across a variety of tasks/data types. In some implementations, example method 1300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

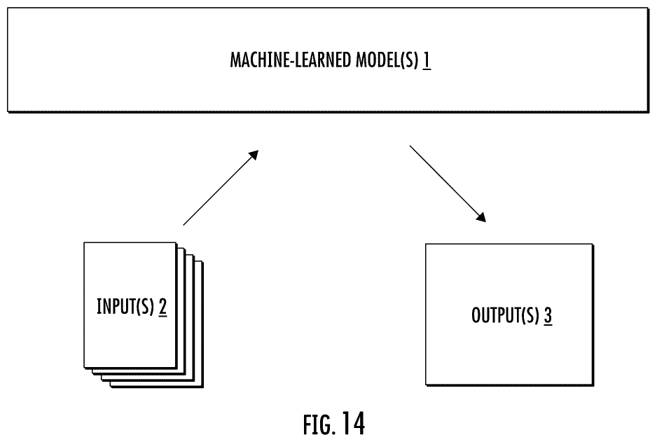

FIG. 14 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

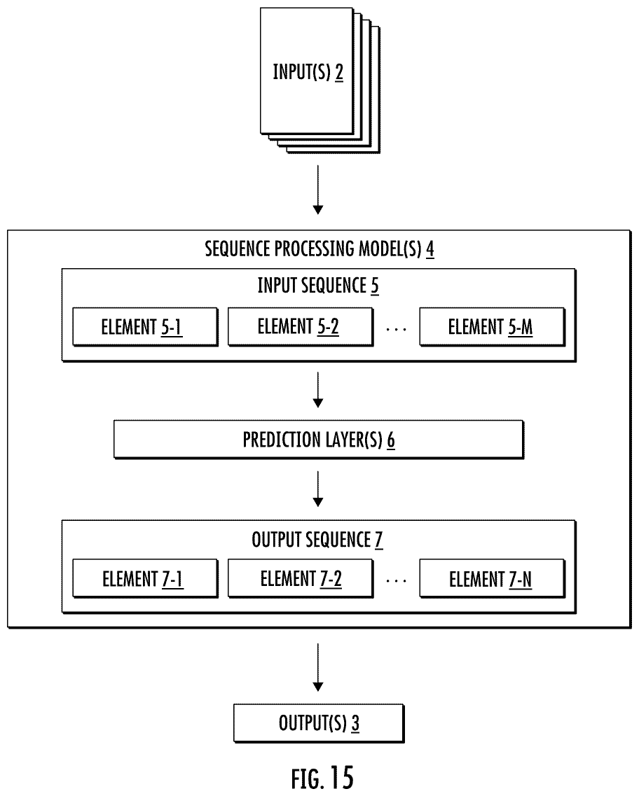

FIG. 15 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 15 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and/or include images/videos with graphical text that has stylizations, and output sequence 7 can represent images/videos with graphical text that has stylizations. Input sequence 5 can represent image, audio, or audiovisual data, and/or include images/videos with graphical text that has stylizations, and output sequence 7 can represent images/videos with graphical text that has stylizations. It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

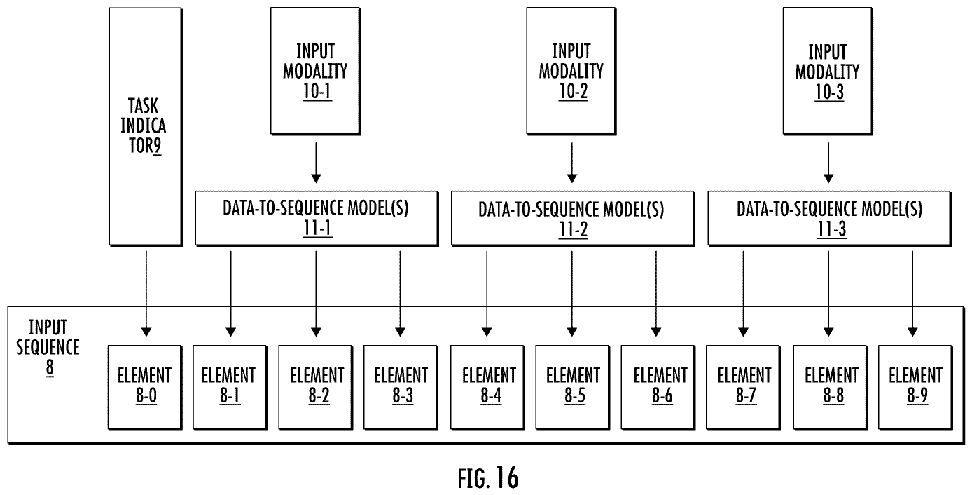

FIG. 16 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

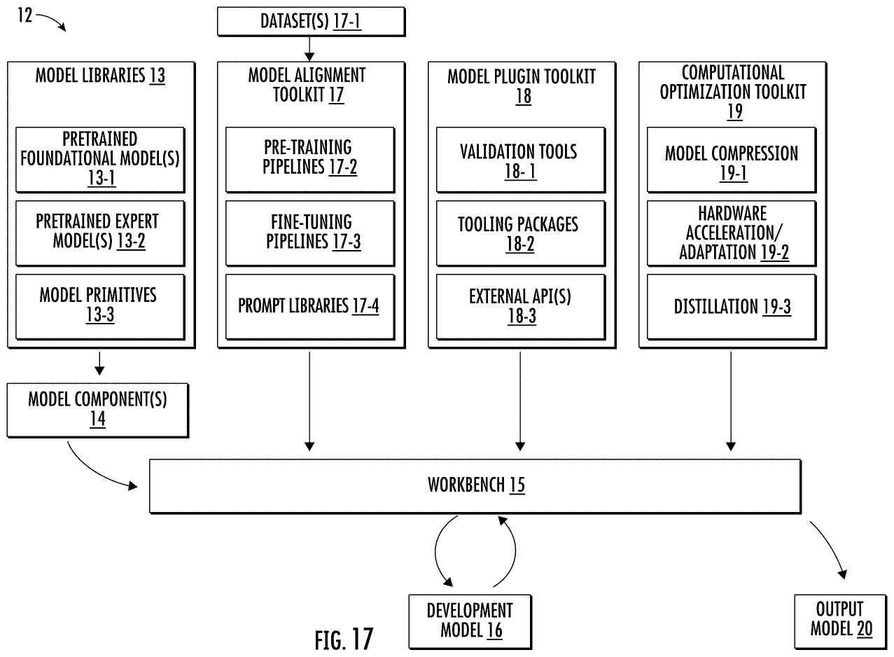

FIG. 17 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

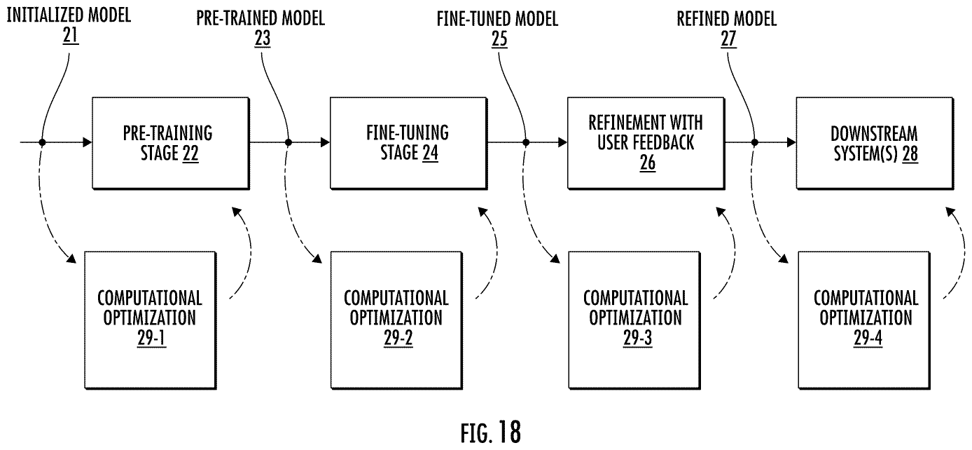

FIG. 18 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 18 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

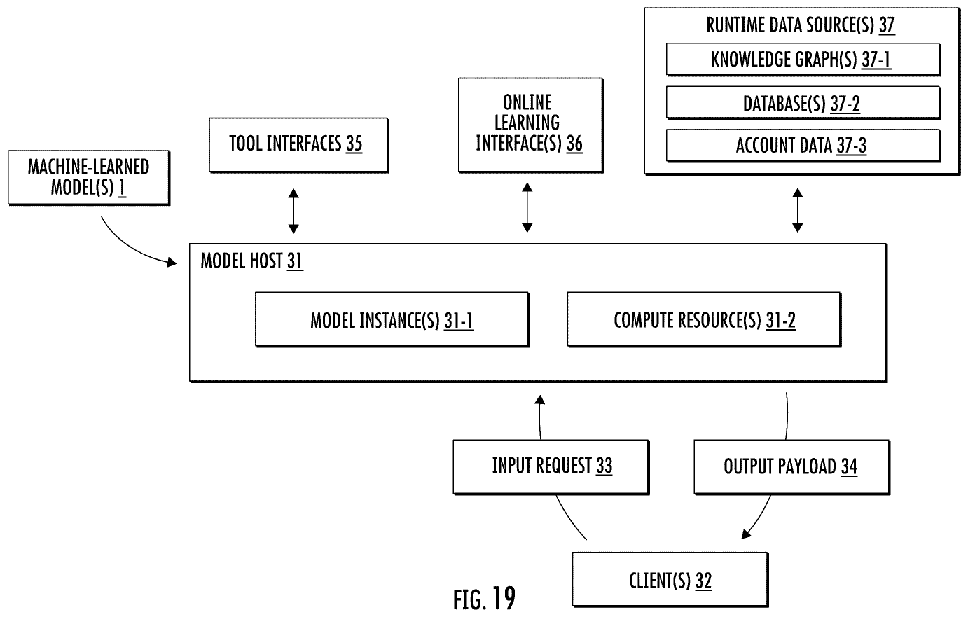

FIG. 19 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data, and/or that include images/videos with graphical text that has stylizations, and to generate output(s) 3 that represent additional images/videos with graphical text that has stylizations according to input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data and/or images/videos with graphical text that has stylizations, responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data and/or images/videos with graphical text that has stylizations, responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer, and/or that include images/videos with graphical text that has stylizations, and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data and/or images/videos with graphical text that has stylizations, responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data and/or images/videos with graphical text that has stylizations, responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content, and/or that include images/videos with graphical text that has stylizations. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.), and/or that include images/videos with graphical text that has stylizations. The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

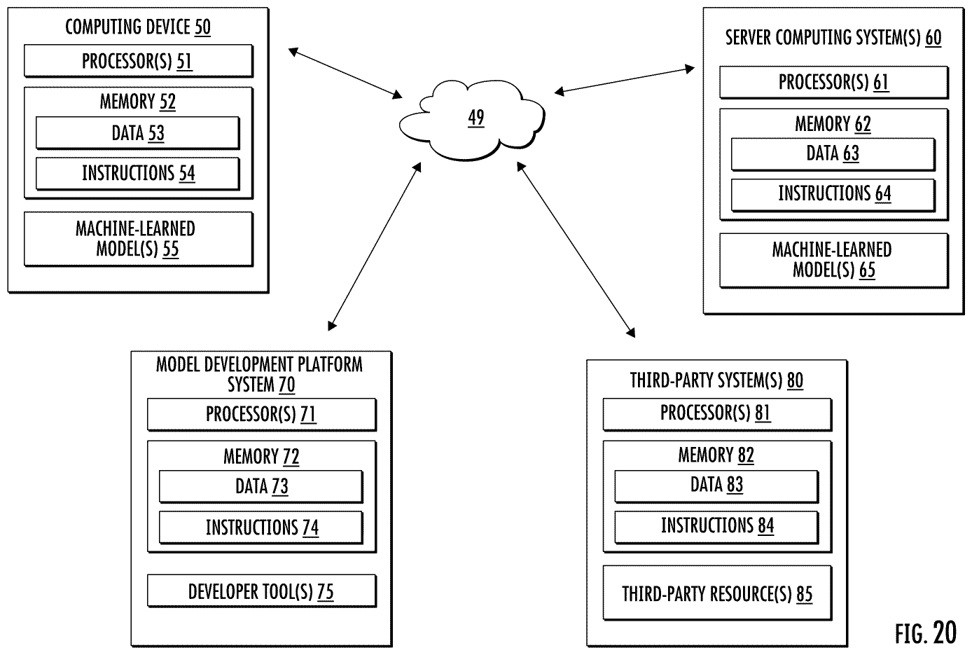

FIG. 20 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 20 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 20 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

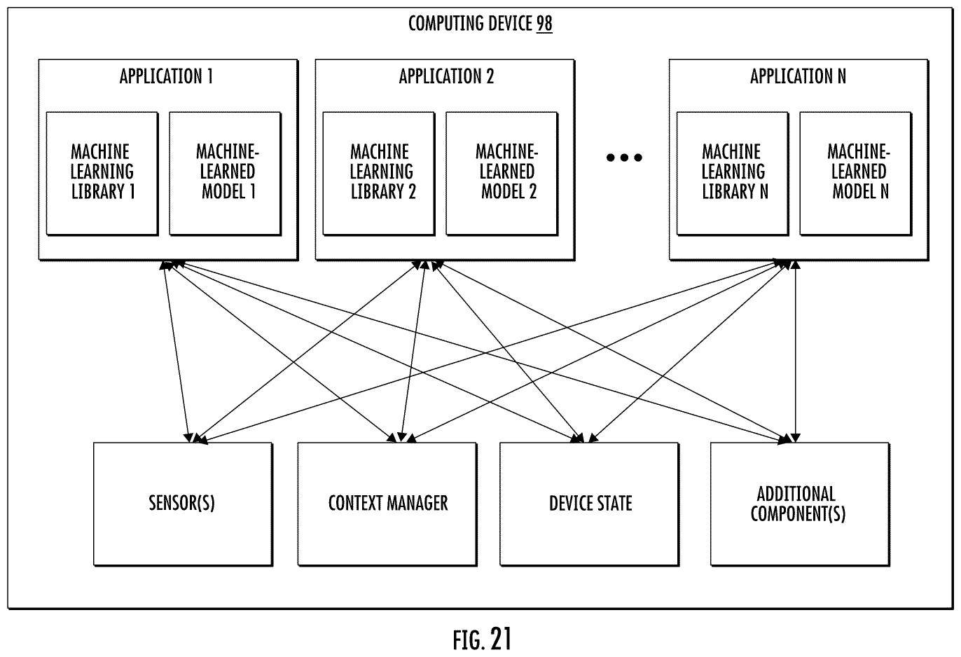

FIG. 21 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 21, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

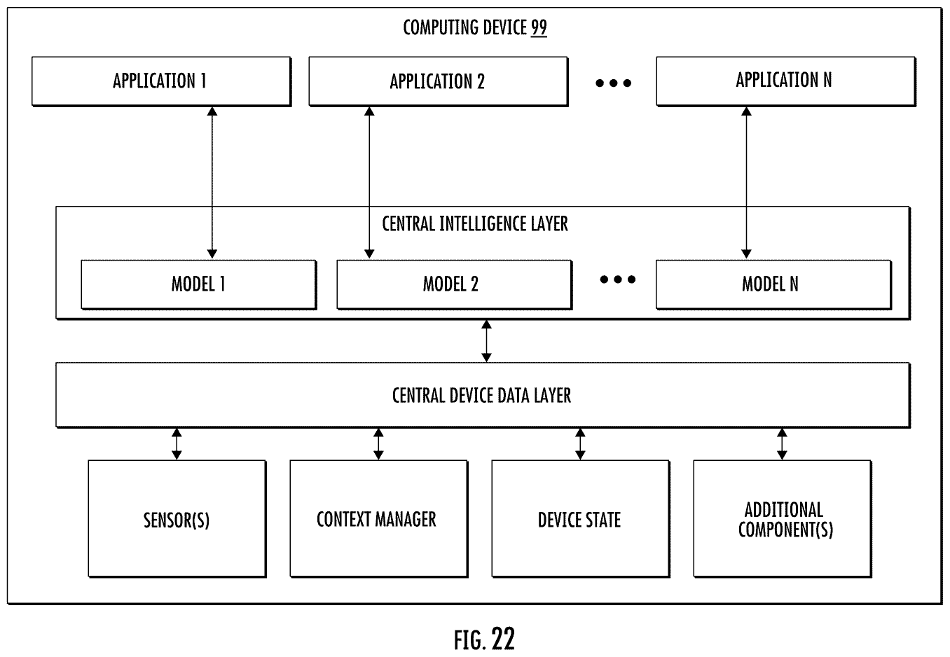

FIG. 22 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 22, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 22, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure covers such alterations, variations, and/or equivalents.

What is claimed is:

1. A computer-implemented method, comprising:
obtaining an animation template, the animation template comprising an image comprising graphical text and a first background, wherein the graphical text comprises one or more first words rendered with a particular stylization;
generating, with a generative language model, a natural language description based on a plurality of tags that comprise data representing a plurality of attributes associated with the graphical text and the animation template;
selecting one or more second words and a second background;
generating an augmented description based on the natural language description, the one or more second words and the second background;
generating, with a rendering engine, a rendered image based on a template and the augmented description, wherein the rendered image comprises rendered text and the second background, wherein the rendered text comprises the one or more second words rendered with the particular stylization; and
generating a training dataset comprising the augmented description and the rendered image.

2. The computer-implemented method of claim 1, further comprising:
obtaining the plurality of tags that comprise the data representing the plurality of attributes associated with the graphical text and the animation template; and
identifying an attribute from the plurality of attributes that describes a characteristic of motion associated with the particular stylization of the graphical text.

3. The computer-implemented method of claim 1, further comprising:
obtaining, as the plurality of tags, at least two of a motion tag, an animation color tag, a font color tag, a font attribute tag, or an emotion tag.

4. The computer-implemented method of claim 1, further comprising:
generating, as the second background, a solid color, an image, or a video.

5. The computer-implemented method of claim 1, wherein the natural language description comprising a first natural language description generated based on a first set of the tags, and further comprising:
generating a second natural language description based on a second set of the tags that is different from the first set.

6. The computer-implemented method of claim 1, wherein selecting the one or more second words comprises selecting the one or more second words from an input text, and
assembling a phrase by ordering the one or more second words,
wherein generating the augmented description comprises generating the augmented description based on the natural language description, the phrase, and the second background.

7. The computer-implemented method of claim 1, further comprising:
performing an optical character recognition (OCR) operation on the rendered image to generate an optical character recognition (OCR) result,
wherein the training dataset comprises the augmented description, the rendered image, and the OCR result.

8. The computer-implemented method of claim 1, wherein the training dataset comprises the augmented description, the rendered image, the tags, the one or more words, and the second background.

9. A computer system, comprising:
one or more processors; and
one or more transitory or non-transitory computer-readable media storing instructions that are executable to cause the one or more processors to perform operations, the operations comprising:
obtaining an animation template and at least one attribute tag, wherein the animation template comprises graphical text and a background, wherein the graphical text comprises a plurality of characters rendered with a particular stylization, and wherein the at least one attribute tag is descriptive of at least one attribute of the particular stylization;
generating at least one description, with a generative language model, based on the at least one attribute tag, wherein each of the at least one description comprises a placeholder associated with text contents of the animation template;
generating a meta-description based on the at least one description;
replacing each of the placeholders of the meta-description with a text string to generate an animation description;
generating, with a rendering engine, a rendered image comprising the text string with the particular stylization; and
storing the animation description and the rendered image as a training example.

10. The computer system of claim 9, wherein one of the at least one attribute is descriptive of motion of the graphical text exhibited via the particular stylization.

11. The computer system of claim 9, wherein one of the at least one description is associated with one of the at least one corresponding attribute.

12. The computer system of claim 9, wherein one of the at least one attribute tag comprises a motion tag, an animation color tag, a font color tag, a font attribute tag, or an emotion tag.

13. The computer system of claim 9, the animation template comprising a first animation template, the at least one attribute tag comprising at least one first attribute tag, the graphical text comprising first graphical text, the background comprising a first background,
further comprising:
obtaining a second animation template different from the first animation template; and
obtaining at least one second attribute tag different from the at least one first attribute tag, wherein the second animation template comprises second graphical text different from the first graphical text, wherein the second animation template comprises a second background different from the first background.

14. The computer system of claim 9, wherein the plurality of characters is assembled into a first phrase in a first language, and the text string comprises a second phrase in a second language that is different from the first language.

15. The computer system of claim 9, wherein the plurality of characters comprises alphanumeric characters, and the text string comprises at least one of one or more logographs, one or more symbols, or one or more emojis.

16. The computer system of claim 9, wherein the training example comprises the animation description, the rendered image, the at least one attribute tag, the text string, a rendered background of the rendered image, and an OCR result, and
wherein the OCR result is generated from the rendered image.

17. One or more non-transitory computer readable media storing instructions that are executable by one or more processors to perform operations comprising:
obtaining an animation template and a plurality of attribute tags, wherein the animation template comprises graphical text, wherein the graphical text is rendered with a particular stylization;
generating a plurality of different descriptions, with a generative language model, based on the plurality of attribute tags, wherein each of the plurality of different descriptions comprise a placeholder associated with text contents of the animation template;
generating a natural language description based on the plurality of attribute tags;
inserting, with the generative language model, instances of a text string into the natural language description to generate an animation description;
generating, with a rendering engine, and based on a template and the animation description, a rendered image comprising the text string with the particular stylization; and
storing the animation description and the rendered image as a training example.

18. The one or more non-transitory computer readable media of claim 17, wherein one or more of the plurality of attributes are descriptive of motion of the graphical text exhibited via the particular stylization.

19. The one or more non-transitory computer readable media of claim 17, wherein a plurality of different descriptions are utilized to generate the natural language description, and wherein one or more of the plurality of different descriptions are associated with corresponding attributes from among the plurality of attribute tags.

20. The one or more non-transitory computer readable media of claim 17, the animation template comprising a first animation template, the natural language description comprising a first natural language description associated with the first animation template, the rendered image comprising a first rendered image, the text string comprising a first text string, the particular stylization comprising a first particular stylization,
further comprising:
generating, with the rendering engine and based on a second natural language description associated with a second animation template, a second rendered image comprising a second text string with a second particular stylization.
